(19) United States
(12) Patent Application Publication
(10) Pub. No.: US 2026/0303197 A1
(43) Pub. Date: Oct. 1, 2026

(54) RELAYS ADAPTING SIGNAL REPRESENTATIONS

(71) Applicant: FRAUNHOFER-GESELLSCHAFT ZUR FOERDERUNG DER ANGEWANDTEN FORSCHUNG E.V., Muenchen (DE)

(72) Inventors: Paul Simon Holt LEATHER, Berlin (DE); Thomas HAUSTEIN, Berlin (DE); Lars THIELE, Berlin (DE); Thomas HEYN, Erlangen (DE); Stefan LIPP, Erlangen (DE); Frank BURKHARDT, Erlangen (DE); Julian POPP, Erlangen (DE)

(21) Appl. No.: 19/535,527

(22) Filed: Feb. 10, 2026

Related U.S. Application Data
(63) Continuation of application No. PCT/EP2024/072650, filed on Aug. 9, 2024.

(30) Foreign Application Priority Data
Aug. 10, 2023 (EP) 23190892.2

(51) Int. Cl. H04B 7/155

(52) U.S. Cl. CPC H04B 7/15542

(57) ABSTRACT

A transceiver is configured for relaying a wireless receive signal in a first signal domain representation as a wireless transmit signal in a second signal domain representation; wherein the transceiver is configured for mapping the receive signal from the first signal domain representation to the second signal domain of the transmit signal when relaying the wireless receive signal.

### CROSS-REFERENCE TO RELATED APPLICATIONS

This application is a continuation of copending International Application No. PCT/EP2024/072650, filed Aug. 9, 2024, which is incorporated herein by reference in its entirety, and additionally claims priority from European Application No. 23190892.2, filed Aug. 10, 2023, which is also incorporated herein by reference in its entirety.

### TECHNICAL FIELD

Embodiments of the present application relate to the field of wireless communication, and more specifically, to relaying signals with a transceiver. Some embodiments relate to non-terrestrial network transceivers.

### BACKGROUND OF THE INVENTION

FIG. 1 is a schematic representation of an example of a terrestrial wireless network 100 including, as is shown in FIG. 1A, a core network 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station (also basestation), BS, refers to a gNB in 5G networks, an eNB in UMTS/LTE/LTE-A/LTE-A Pro, or just a BS in other mobile communication standards. A user may be a stationary device or a mobile device.

The network 100 may comprise one or more transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

The wireless communication system may also be accessed by mobile or stationary IoT devices which connect to a base station or to a user. The mobile devices or the IoT devices may include physical devices, ground-based vehicles, such as robots or cars, aerial vehicles, such as manned or uncrewed aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an example of five cells, however, the RANₙ may include more or fewer such cells, and RANₙ may also include only one base station. FIG. 1B shows two users UE₁ and UE₂, also referred to as user equipment, UE, that are in cell 106₂ and that are served by base station gNB2. Another user UE₃ is shown in cell 106₄ which is served by base station gNB4. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1B shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. Furthermore, some or all of the respective base stations gNB₁ to gNB₅ may connected, e.g., via the S1 or X2 interface or the XN interface in NR, with each other via respective backhaul links 116₁ to 116₅, which are schematically represented in FIG. 1B by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI), respectively. For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTIs) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the terrestrial wireless networks described above, non-terrestrial wireless communication networks exist including spaceborne transceivers, like satellites, and/or airborne transceivers, like uncrewed aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station cannot provide sidelink resource allocation configuration or assistance for the UEs, and/or
may be connected to the base station that cannot support NR V2X services, e.g., GSM, UMTS, LTE base stations.

When considering two UEs directly communicating with each other over the sidelink, e.g., using the PC5 interface, one of the UEs may also be connected with a BS, and can thus relay information from the BS to the other UE via the sidelink interface. Such relaying can be performed in the same frequency band (in-band-relay) or another frequency band (out-of-band relay) can be used. In the first case, communication on the Uu and on the sidelink may be decoupled using different time slots as in time division duplex, TDD, systems.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2B is a schematic representation of an out-of-coverage scenario in which the UEs directly communicating with each other are either not connected to a base station, although they can be physically within a cell of a wireless communication network, or some or all of the UEs directly communicating with each other are communicating with/connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each other, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

A scenario described herein may not only comprise nodes like base stations, UEs, IoT devices, but also transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

In a wireless communication system by way of non-limiting example such as described above, a drawback exists, in particular in UE-to-satellite communication (U2SC) systems and/or UE-to-UAV systems (uncrewed aerial vehicle such as drones, balloons and the like) forming an implementation of the above-described networks. In particular, when considering a scenario at the UE-level in which the UE suffers from transmit power restrictions and is restricted in its use of higher order MIMO capabilities. The latter results from the restricted size of a typical hand-portable UE and the limited number of antennas that it can therefore support. Similarly, satellites that form part of a U2SC system are typically constructed to have only one antenna and at best, when two antennas are available, only polarization diversity can be provided which limits the capability of a communication link. However, it is difficult or even impossible to change capabilities of satellites that have been launched already.

There is, thus, a need to improve wireless communications.

It is noted that the information in the above section is only for enhancing the understanding of the background of the invention and therefore it may contain information that does not form conventional technology and is not yet known to a person of ordinary skill in the art.

### SUMMARY

An embodiment may have a transceiver configured for relaying a wireless receive signal in a first signal domain representation as a wireless transmit signal in a second signal domain representation; wherein the transceiver is configured for mapping the receive signal from the first signal domain representation to the second signal domain representation of the transmit signal when relaying the wireless receive signal.

Another embodiment may have a device configured for utilizing a wireless communication link that has a transceiver for relaying a wireless signal towards or from the device, wherein the device is configured for providing a selection information indicating a part of a payload data to be forwarded by the transceiver; and/or wherein the device is configured for receiving a plurality of relayed signals from a corresponding plurality of transceivers; the plurality of payload data being associated with a same signal source that has transmitted the plurality of payload data with a same signal.

### BRIEF DESCRIPTION OF THE DRAWINGS

Embodiments of the present invention are described herein making reference to the appended drawings, in which:

FIG. 1A shows a schematic representation of an example of a wireless communication system;

FIG. 1B shows a schematic representation of an example of a radio access network that may include one or more base stations;

FIG. 2A is a schematic representation of an in-coverage scenario in which UEs directly communicating with each other are connected to a base station;

FIG. 2B is a schematic representation of an out-of-coverage scenario in which UEs directly communicating with each other receive no SL resource allocation configuration or assistance from a base station;

FIG. 3 is a schematic representation of a partial out-of-coverage scenario in which some of the UEs directly communicating with each other receive no SL resource allocation configuration or assistance from a base station;

FIG. 4 is a schematic representation of an in-coverage scenario in which UEs directly communicating with each other are connected to different base stations;

FIG. 5 is a schematic representation of a wireless communication system comprising a transceiver, like a base station or a relay, and a plurality of communication devices, like UEs, according to an embodiment;

FIG. 6 shows a schematic representation of a wireless communication network according to an embodiment having a relay device;

FIGS. 7A-7B show schematic representations of a wireless communication network to an embodiment in uplink and downlink to illustrate a FDD/TDD conversion of relayed signals;

FIGS. 8A-8B show schematic representations of a wireless communication network to an embodiment in uplink and downlink to illustrate a FDD/TDD conversion of relayed signals comprising a restructuring of signals;

FIGS. 9A-9B show schematic representations of a wireless communication network to an embodiment in uplink and downlink to illustrate a coordinated use of a plurality of relay devices;

FIGS. 10A-10B show schematic representations of a wireless communication network to an embodiment in uplink and downlink to illustrate a coordinated use of a plurality of relay devices that only forward a part of a received signal;

FIGS. 11A-11B show schematic representations of a wireless communication network to an embodiment in uplink and downlink to illustrate a coordinated use of a plurality of relay devices that implement spatial streams for forwarding signals;

FIGS. 12A-12B show schematic block diagrams of a wireless communication network adapted for providing relaying services according to embodiments;

FIGS. 13A-13E show schematic block diagrams of wireless communication networks for further illustrations of path options according to embodiments;

FIG. 14 shows a schematic flow chart of a method for operating a transceiver, according to an embodiment;

FIG. 15 shows a schematic flow chart of a method for providing selection information according to an embodiment; and

FIG. 16 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

Embodiments of the present invention are described herein whilst making reference to a relay device. Such a relay device may be a device being constructed to operate as a stationary or mobile device but is not limited hereto. According to an embodiment of the present invention, the relay device may be implemented by other types of transceivers for wirelessly transceiving signals, e.g., a user equipment that is operated in such an operation mode. That is, also a user equipment may operate as a relay device as well as other transceivers.

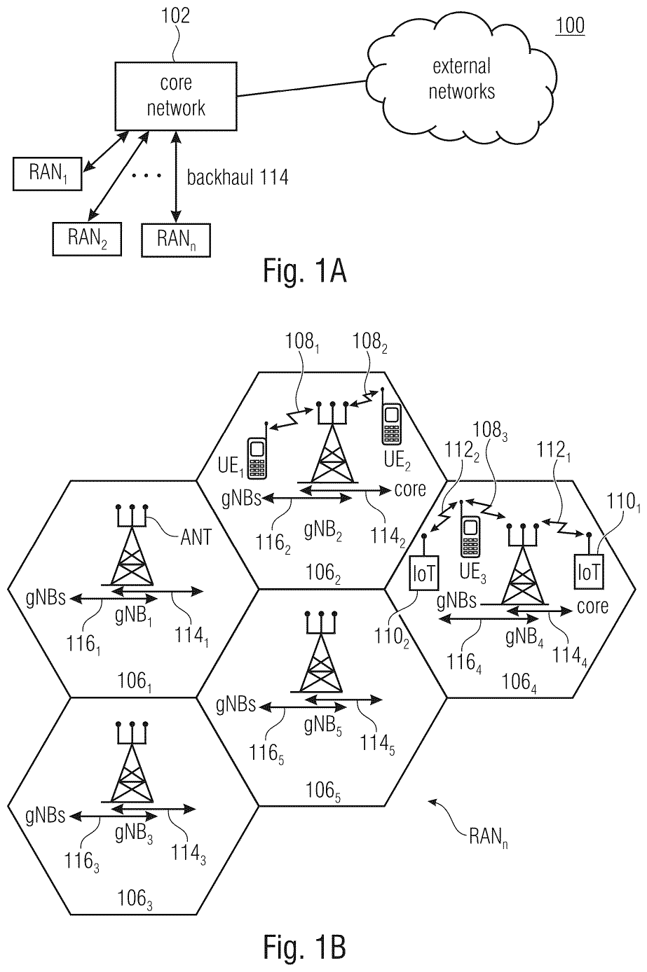

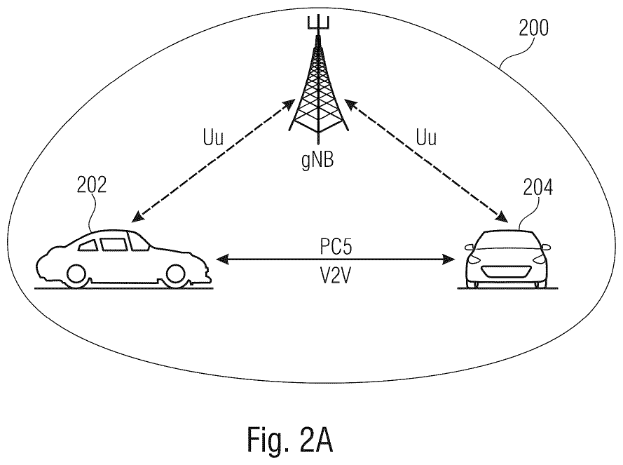

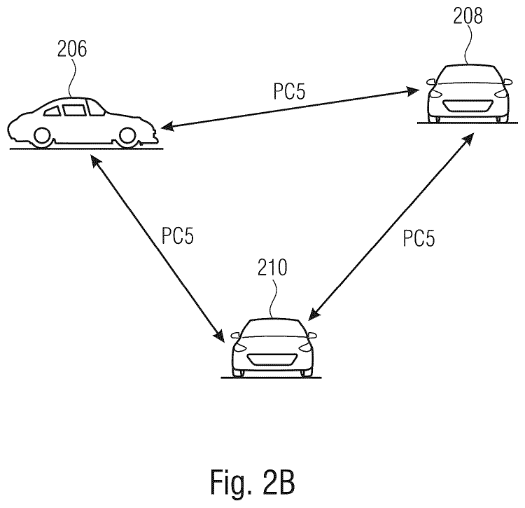

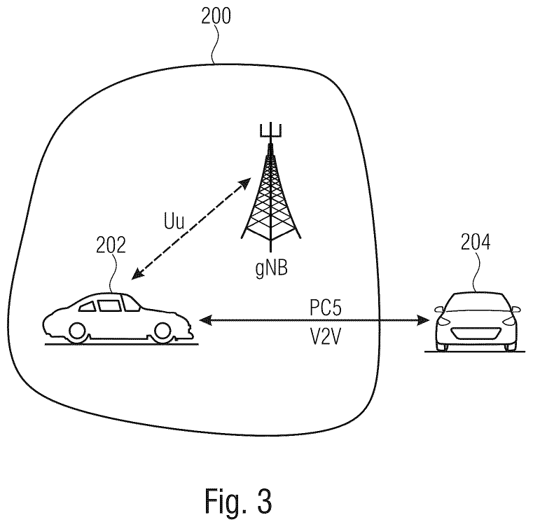

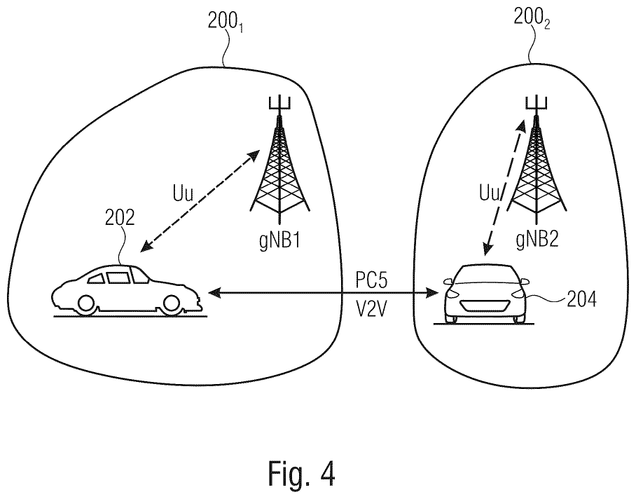

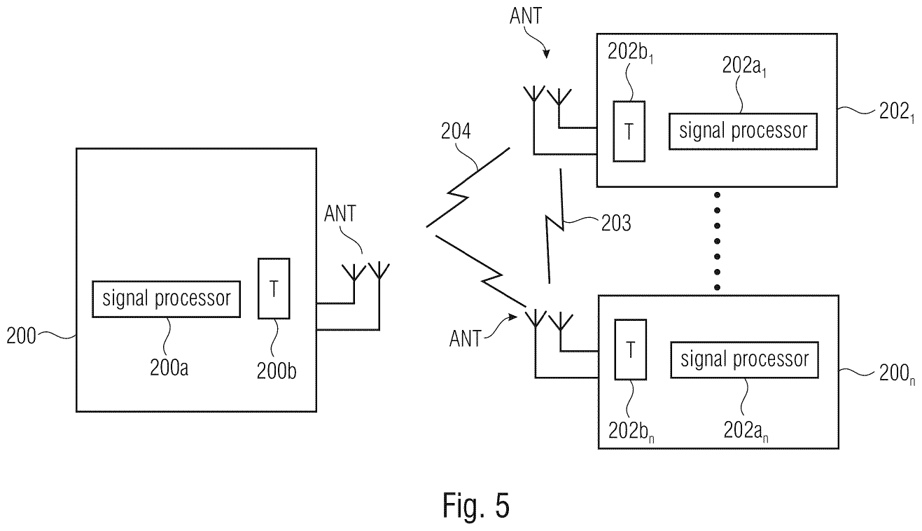

Embodiments of the present invention may be implemented in a wireless communication system or network as depicted in FIGS. 1 to 4 including a transceiver, like a base station, gNB, or relay, and a plurality of communication devices, like user equipment's, UEs. FIG. 5 is a schematic representation of a wireless communication system comprising a transceiver 200, like a base station a transmission reception point, TRP, or a relay, and a plurality of communication devices 202₁ to 202n, like UEs. The UEs might communicate directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the Uu interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein.

Some embodiments of the present invention in particular relate to wireless communication provided between a terrestrial unit like an IoT device or in particular a user equipment, or a base station on the one side and a spaceborne transceiver like a satellite, s space station or spaceship on the other side. Instead or as an alternative to a satellite an uncrewed aerial vehicle, UAV, may be used.

In view of the above-identified drawbacks of limitations as well at the spaceborne side and at the terrestrial side, communication between devices may benefit from using a transceiver or relay device. Different modes of relaying a signal between terrestrial devices are known, e.g., an amplify and forward mode, a band switch amplify and forward mode, a digitise and forward mode or a store and forward mode. Embodiments of the present invention relate to relay devices for providing at least a path or a multipath component between devices. Some embodiments relate to relaying signals between flying transceivers, in particular spaceborne transceivers such as satellites/UAV and terrestrial transceivers, amongst them mobile and immobile transceivers, in particular but not limited user equipment, UE.

Relaying for cellular technologies is currently defined as centrally-coordinated, terrestrial relaying, in which the base station (BS) defines resources that are used by the relay for the relaying of the signal. This is done in a decode-and-forward or amplify-and-forward manner. The relay is either used as an alternative transmission path or as a range extender for the BS (integrated access and backhaul (IAB) or sidelink). In IAB the BS is called a donor node as it reserves some of its resources to be used by the relay for the purpose of relaying. [TS 138 174 V16.7.0]

Currently the, relevant topic discussed in 3GPP standardisation is that of sidelink relaying which is a type of device-to-device relaying supporting only one device at a time.

Non-terrestrial network, NTN, standard does not support relaying up to Rel-17 and Rel-18. Due to restricted spectrum resources, a coexistence of NTN and terrestrial networks is not yet considered in frequency range 1 (FR1). Regardless of this however, Mediatek has proposed the investigation of spectrum coexistence with an initial focus on FR1 [RWS-230110]. In frequency range 2 (FR2), at least a limited coexistence in FR2 is considered possible.

The contribution by the satellite industry does not propose relaying for Rel-19 [RWS-230048], but either gNB on board of a satellite, or at least gNB-DU on board with CU-CP on ground.

3GPP does not consider MIMO over satellite, but selects the polarization (RHCP, LHCP). This is currently being considered by 5GAA (=single input single output, SISO, operation of a NTN terminal).

In IEEE, relaying is considered in IEEE 802.11p which represents a CSMA based relaying of broadcast messages.

In the case of geostationary earth orbiter, GEO, satellites, communication to satellites is either ensured by large terminals, and in the best-case nomadic terminals, fitted with highly directive antennas. These either employ no form of MIMO at all or, when they do, use different polarizations to establish a MIMO link to the satellite. The benefit which could be achieved by this sort of MIMO was analysed in the ESA project MIMOSA. The MIMO channel for this transmission is limited to 2×2 MIMO, with limited MIMO gain.

In case of LEO and MEO satellites massive MIMO has been proposed for the downlink to enhance the throughput data rate [1].

Reference [2] also handles the subject but aims at optimizing the network throughput.

References [3], [4], [5] analyse the MIMO gain which is achievable by a certain satellite constellation.

Reference [6] assumes a GEO satellite as a relay for LEO satellites.

References [7] and [8] introduce relay links to LEO satellites from High Altitude Platforms, but target BS to high altitude platform (HAP) communication.

The idea is to enable an additional layer in the discussed xG-NTN-3D constellations, a distributed terrestrial repeater/aggregator layer which is capable of serving as a distributed smart antenna array that also has the potential of combining satellite and terrestrial communications.

Some embodiments of the present invention relate to two main technical aspects and their combination:
1. Relay with a capability to provide a duplex translation between TDD and FDD, e.g. to relay a terrestrial link between a UE and a relay operated in TDD to a satellite link between the relay and a gNB via a satellite or UAV operating in FDD.
2. Relay or a multitude of (distributed) relays to provide an adaptation or translation functionality for spatial degrees of freedom (MIMO) and bandwidth to be used e.g., between indoor and outdoor radio resources, when e.g. the spatial degrees of freedom are limited on one of the two links (e.g. indoor link vs. outdoor link or first vs. second hop). This solution enables cell free operation of the ground segment (relay-UE link) which is, in addition, MNO independent. In contrast to that a simple indoor to outdoor relaying would not be able to maximize or optimize the spatial stream performance and might suffer from impairments such as the keyhole effect. Additionally, a layer 3 relaying would cause excess delay due to the necessity to decode and would be provider specific.
3. Combinations of 1 and 2: Example is given by a remote local manufacturing or building site operating on 5G-NR devices (TDD) without NTN capabilities. Locally-installed relays which are able to handle TDD towards the UEs on ground and handling FDD satellite or UAV links towards the network side. A particular difference to SOTA layer 3 relays is that a transparent translation of TDD to FDD resources is performed allowing a significant reduction of latency and relaying without the need for decoding. Furthermore, a distribution of relay nodes may provide macro diversity on the TDD link and therefore higher order MIMO layers for a particular UE or a group of UEs.

For example, a relay device presented herein may be adapted for relaying between a terrestrial and a non-terrestrial communication link. The aspects described above represented in the finding underlying the present invention that wireless communication may benefit from changing a signal representation of a relayed signal when relaying the signal.

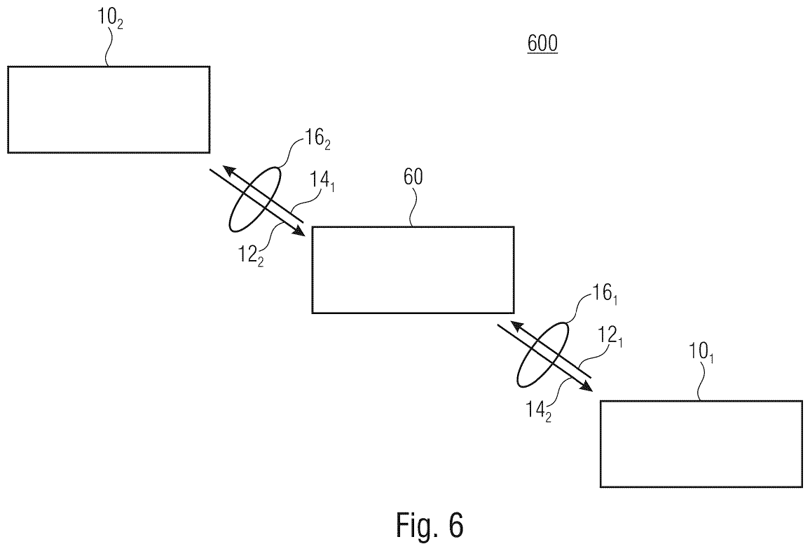

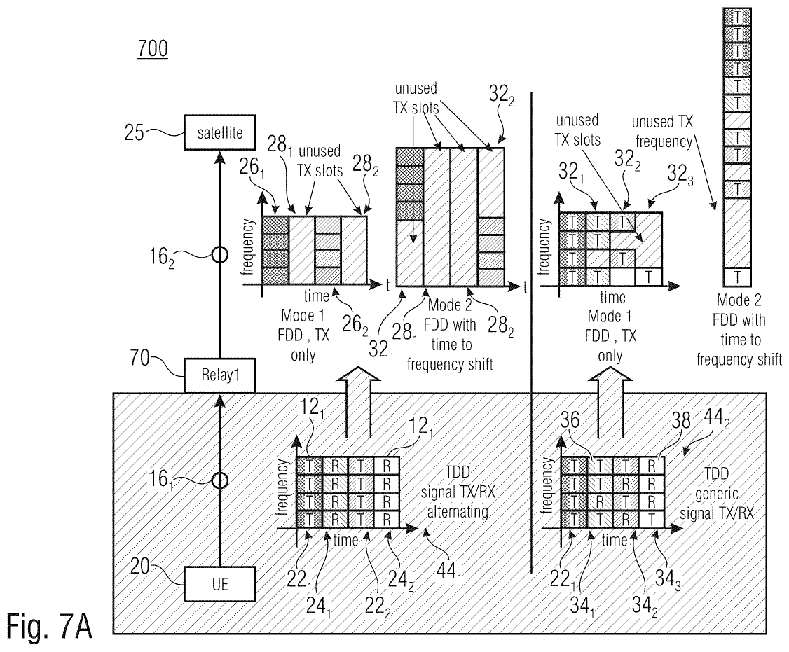

According to an embodiment, a relay device such as a relay device shown in FIG. 6 is provided. In FIG. 6, a part of a wireless communication network 600 is shown. A transceiver, e.g., a relay device 60 according to an embodiment is configured for relaying a wireless receive signal 12₁ as a wireless transmit signal 14₁. For example, the wireless receive signal 12₁ may be received from a device 10₁ and the wireless transmit signal 14₁ may be transmitted to a device 10₂. Alternatively or in addition, the relay device 12₂ may receive a wireless receive signal 12₂ from device 10₂ and may transmit, based on the wireless receive signal 12₂ a wireless transmit signal 14₂ to the device 10₁ or to a different device. When compared to the wireless receive signal 12₁, the wireless transmit signal 14₁ may comprise a different signal domain representation and/or the wireless transmit signal 14₂ may comprise a different signal domain representation when compared to the wireless receive signal 12₂.

The transceiver/relay device 60 is configured for mapping the wireless receive signal 12₁ from the first signal domain representation to the second signal domain representation of the wireless transmit signal 14₁ when relaying the wireless receive 12₁. For relaying the wireless receive signal 12₂, the relay device 60 may operate accordingly. The wireless receive signals 12₁ and 12₂ may each be received in different domains including a spectral domain, a temporal domain, a spatial domain and/or a polarization domain. Such a consideration or representation may also include several of the mentioned domains, i.e., a combination thereof. A swapping or a mapping from the signal domain representation of the wireless receive signal 12₁ or 12₂ to the signal representation of the wireless transmit signal 14₁, 14₂ respectively may lead to the effect that the wireless transmit signal has a different appearance when transmitted and viewed or represented in these domains. This may be understood that it is possible but not necessary that the relay device maps the receive signal 12₁ from a single domain such as spectral, temporal, spatial and polarization and/or other representation domains to a single different domain. It is of advantage that the signal domain representation between the wireless receive signal and the resulting wireless transmit signal is changed across at least two, three or even all four of the mentioned domains. According to an embodiment, the first signal representation and the second signal representation differ from each other in at least two of:
a time domain (e.g. delay, repetition, store and forward);
a delay domain (e.g. cyclic delay diversity, delay precoding in orthogonal time frequency space, OTFS);
a frequency domain (e.g. frequency translation);
a Doppler domain (e.g. Doppler precoding in OTFS);
a power domain (e.g. amplification through repeaters);
an energy domain (e.g. distribution of signal power over time and frequency);
a code domain (e.g. different spreading and scrambling sequences, fountain codes or code rates the Code domain may include different code rate as well, i.e. different Modulation and/or Coding schemes MCS index);
an orbital angular momentum domain;
a spatial domain (e.g. patterns, beam formers, sectors, directions);
a coverage domain (e.g. indoors, outdoors); and
a polarisation domain (e.g. linear to linear, linear to circular, circular to linear).

This may also allow that some representations may remain unchanged, not excluding that all representations may be changed when relaying a signal. That is, the receive signal can be viewed in different domains including spectral, temporal, spatial and polarisation. The swapping or mapping effectively changes the signal such that it will have a different appearance when transmitted and viewed in these domains. This may be understood as not mapping a signal from one single domain a different single domain. Instead, according to an embodiments, the relay device may change the signal representation across at least two domains. Therefore, in view of the overall list of representations the received signal may be mapped/transferred to a transmit signal such that its representation in those domains is the same or different.

The devices 10₁ and 10₂ may be wireless transmitters or transceivers. Each of the wireless transceivers 10₁ and 10₂ may be implemented independently as a terrestrial or non-terrestrial device. For example, the relay device 60 may relay signals between two terrestrial devices 10₁ and 10₂ such as a UE or between two non-terrestrial devices such as satellites or UAVs. In an advantageous embodiment, the relay device 60 is adapted to relay signals between a non-terrestrial device and a terrestrial device such as a UE. That is, according to an example, one of the devices 10₁ is a terrestrial UE and the other device from the group of devices 10₁ and 10₂ may be a spaceborne transceiver.

A direction along which the relay device 60 is capable of relaying signal may be unidirectional or bidirectional of higher order. For example, a link 16₁ between the relay device 60 and the device 10₁ may be a unidirectional or a bidirectional link. A link 16₂ between the relay device 60 and the device 10₂ may be, independently from a unidirectional or bidirectional implementation of link 16₁, unidirectional or bidirectional. In case of both links 16₁ and 16₂ being bidirectional, a bidirectional communication between devices 10₁ and 10₂ may be supported by relay device 60. That is, the relay device 60 may provide for an unidirectional or bidirectional link between devices 10₁ and 10₂. According to an example, the relay device may provide the communication between the devices 10₁ and 10₂, at least in an uplink direction or a downlink direction between the device 10₁ and 10₂, unidirectional, wherein an implementation of both may allow for a bidirectional communication.

According to an embodiment, the relay device 60 is configured for performing, by the relaying provided by relay device 60, a mapping between a first duplex scheme of the first link between device 10₁ and the relay device 60 and a second duplex scheme of the link 602 between device 10₂ and the relay device 60. Device 10₂ may be a single device but may also comprise a group of devices, e.g., for implementing a groupcast, a multicast or a broadcast scenario. As a duplexing, there may be understood a mapping onto shared resources, e.g., in the time/frequency domain to separate uplink and downlink resources. For example, the relay device 60 may be adapted to translate or remap between different duplex schemes implemented in links 16₁ and 16₂, e.g., to conserve a throughput and/or a latency or other quality parameters. Alternatively or in addition, the relay device 60 may puncture a link and add the redundancy information on the other link.

According to an example, the relay device 60 may be configured for mapping between a time division duplex, TDD, scheme of a time domain and a frequency division duplex, FDD, a scheme of a frequency domain when relaying the wireless receive signal. For example, the relay device 60 may be configured for operating one of the links 16₁ and 16₂ to a terrestrial UE in TDD and another link between the relay device and a satellite or a UAV in FDD. That is, when relaying the receive signal, e.g., receive signal 12₁, same may be mapped to a TDD scheme and the relay device 60 may transmit the wireless transmit signal 14₁ according to the FDD scheme. Alternatively, the relay device 60 may be configured for receiving the wireless receive signal 12₁ as a signal according to the FDD scheme and for transmitting the wireless transmit signal 14₁ according to the TDD scheme. Along the opposing direction from device 10₂ towards the device 10₁, a similar approach may be implemented.

Beyond those single-domain adaptations, the relay device 16 may be configured for mapping between a time division duplex, TDD, scheme of a time domain and a space division duplex, SDD, of a spatial domain when relaying the wireless receive signal. Alternatively or in addition, the relay device 16 may be configured for mapping between the FDD scheme and the SDD scheme when relaying the wireless receive signal 12₁ and/or 12₂.

According to an example, the relay device 60 may be configured for receiving the wireless receive signal 12; and/or 12₂ as a signal according to the SDD scheme and for transmitting the wireless transmit signal 14₁, 14₂ respectively according to the FDD scheme.

NTN Relaying Node with MIMO Capability

### Simple Relay Principle

An illustrative and possible simple approach for obtaining a solution for the underlying technical problem may be considered as a single repeater such as relay device 60, which can be used or operated to highlight part of the principle. This may relate to an operation according to an amplify-and-forward repeater, a digitize-and-store/forward repeater or a decode-and-store/forward repeater. The latter may be more or less similar to an intermediate/remote base station, which simply transfers the terrestrial communication to the satellite/UAV communication path.

The relay device 60 may provide on the first hand a power benefit. The UE only needs to reach the relay device 60, which may have less or even no power source limitations and may take care of the communication to the other end, e.g., the satellite or UAV. Additionally, the relay device 60 may adapt the protocol such that it is complying with NTN requirements, e.g., requiring decode and forward or at least digitize and forward. Therefore, according to an embodiment, the relay device 60, e.g., as a repeater may act as a fixed position UE, which provides UE-UE relaying to the mobile node. This may resemble the satellite/UAV or the feeder station to act similarly to an IAB-donor node. This may impact the system in such a way, that increasing the number of UEs could consume the resources of the satellite/UAV system. Each UE would thus require the resources both on the UE-relay link and on the relay-satellite or relay-UAV link. This may be addressed by including a frequency shift, so that the time-frequency resources of the UE-relay link, e.g., link 16₁ and the relay-satellite/UAV paths, e.g., link 16₂ are independent of each other. For example, based on an assumed higher altitude position of the relays and the satellites/UAVs, the issue of interference of the relay-satellite/UAVs link with terrestrial communication can be reduced via beamforming. For example, with higher altitude relays the antennas patterns of the relay may act as a separator between the terrestrial system and the satellite system, assuming that the terrestrial Tx signal is not powerful enough to reach the satellite and other way around that the satellite signal is not strong enough to affect the terrestrial UEs.

As indicated above, when referring to a satellite in connection with embodiments, in particular in connection with a communication path making benefit from relaying, as an alternative or in addition, an UAV may be used as it may provide for similar characteristics, at least in parts, e.g., in view of a high possibility to provide unblocked LoS paths and the like.

Based thereon, another improvement provided by embodiments utilizes the FDD configuration of satellite transmissions. Typically the communication to a satellite follows an FDD scheme as a TDD scheme would involve unwantedly long waiting times due to the significant transmission latency introduced by the long transmission distance. Therefore, according to an embodiment, the relay device 60 may be capable of converting a TDD scheme to an FDD scheme. With this, it becomes possible to frequency shift and aggregate the transmission signals on the relay-to-satellite link and vice versa, providing that there is a duplex translation between TDD and FDD.

Depending on the Tx/Rx ratio, the TDD/FDD conversion and aggregation can be done in different ways. With a 50/50 ratio, the RX-timeslots could be used either for transmission of TX-timeslots or for the transmission of additional redundancy. This may also take a second polarization of the satellite link into account. So assuming that the bandwidth is maintained, a redundancy factor of 4 could be achieved for Tx. Assuming that the Tx/Rx ratio is not 50/50, a maximum bandwidth on the satellite side would be defined and, depending on the ratio, the transmission redundancy can be defined to fill the available transmission slots.

That is, a relay device according to an embodiment, may be configured for adapting a ratio between a first amount of wireless transmit signals that are transmitted based on a second amount of wireless receive signals. For example, the relay device may be configured for providing a predefined, e.g., maximum bandwidth for transmitting the wireless transmit signals and for using available further slots of the TDD scheme for a transmission redundancy associated with the wireless transmit signal.

According to an embodiment, the relay device may be configured for using a receive, RX time slot of the TDD scheme for a transmission of a TX time slot of the TDD scheme or for transmitting redundancy information for the wireless transmit signal. Such transmission may be directed to a transmitter of the receive signal or may be used differently. For example, other signals and/or signals to other nodes may be transmitted such as a redundancy version of the message to be provided to the final receiver using the UL slot of that device for providing the copy. This is based on the finding that, e.g., when referring to FDD and when compared to TDD, some resources of the TDD might be available for other purposes. Beside a redundancy version also type of information associated with the receive signal or a former or previous receive signal may be transmitted, e.g., a redundant copy of at least parts of the wireless transmit signal including full or partial redundancy.

Additionally or as an alternative to this, the relay device 60 may be configured to encapsulate the transmission data, i.e., payload of a receive signal to be forwarded to a satellite, into a satellite link specific protocol. This could be done even if only digitize and forward is used, possibly avoiding a decoding.

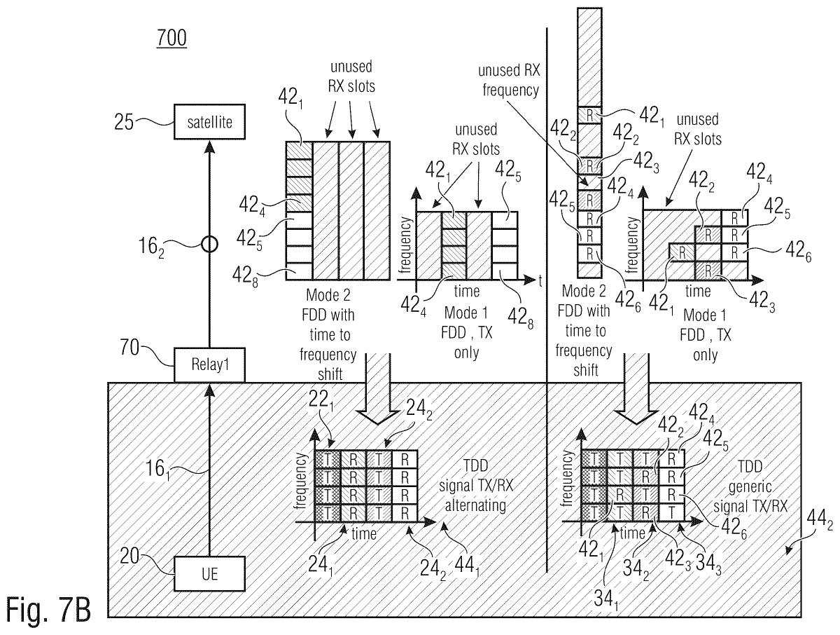

FIG. 7A shows a schematic block diagram of at least a part of a wireless communication network 700 comprising a transceiver/relay device 70 according to an embodiment that may be in accordance with relay device 60 but that has at least some further capabilities, e.g., including storing, aggregation/condensing, compression and/or mapping from time frequency resources from the TDD access link 16₁ to time frequency resources on the FDD satellite link 16₂. Link 16₁ may be an uplink between a UE 20, e.g., one of the devices 10₁ and 10₂ and link 16₂ may be a link between the relay device 70 and a satellite 25, e.g., the other one of devices 10₁ and 10₂. The UE 20 may use a TDD scheme according to which TX slots 22₁, 22₂, . . . may be provided as well as RX slots 24₁, 24₂, . . . , the slots occupying the respective assigned frequency range. Wireless receive signal 12₁ of relay device 70 may occupy TX slots 22₁ and 22₂ used by the UE 20. Accordingly, RX slots 24₁ and 24₂ may remain unconsidered for a link 16₂ where, in Mode 1 FDD TX slots 261 and 262 may be occupied whilst slots 28₁ and 28₂ may remain unused. When considering Mode 2 FDD with a time to frequency shift completely unused slots 28₁ and 28₂ may be obtained as well as partially unused 32₁ and 32₂.

Further, in FIG. 7A there is shown an alternative to the slot-wise association of resources where not only a TX slot 22₁ is present but also one or more mixed slots 341 to 343 having TX parts 36 and RX parts 38, wherein, for the uplink, only the TX parts 36 contribute to the load, leading to at least partially unused slots 32₁ to 32₃ in Mode 1 and also to unused resources in Mode 2 FDD with the time to frequency shift.

In FIG. 7B there is shown a downlink scenario using the devices corresponding to FIG. 7A. Information 42₁ to 42₈ received via link 16₂ by relay device 70 may be mapped to the TDD scheme, at least the RX slots 24₁ and 24₂. Similarly, in Mode 1 FDD although receiving the information according to a different scheme, the relay device 70 may map the information according to link 16₁.

A similar approach may be implemented in the generic TDD scheme having the mixed slots 34₁ to 34₃.

In other words, FIGS. 7A and 7B show schematic diagrams representing a frequency shift for FDD and aggregation/delayed aggregation in a simple variant with single repeater.

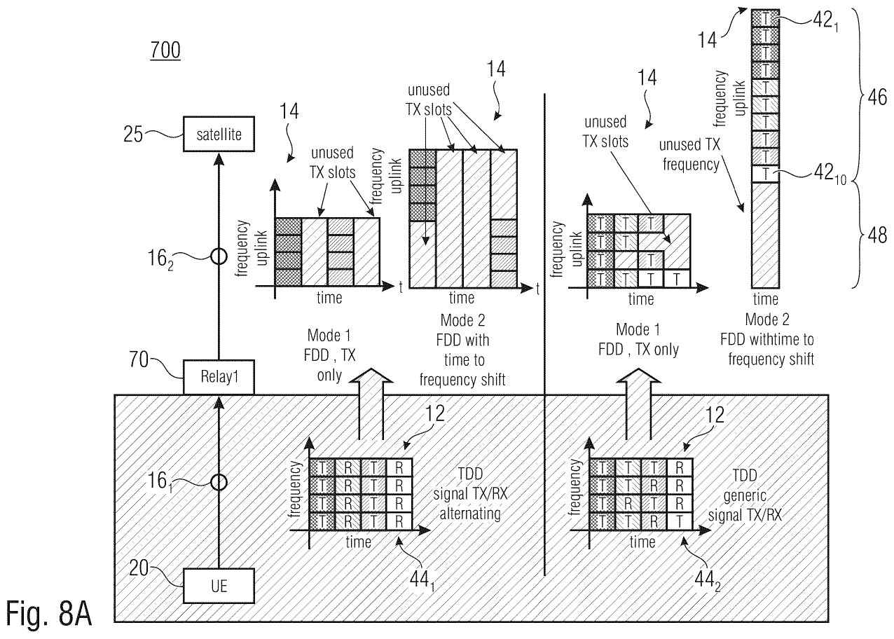

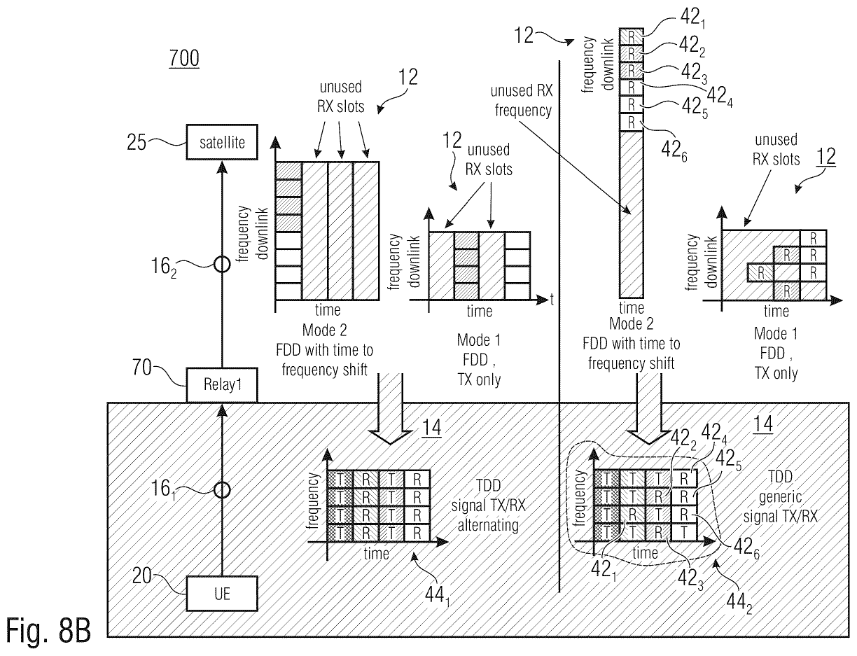

FIGS. 8A and 8B show an enhanced implementation of the wireless communication network 700 represented in FIGS. 7A and 7B, wherein FIG. 8A relates to the uplink scenario corresponding to FIG. 7A and FIG. 8B relates to the downlink scenario according to FIG. 7B. Referring to FIG. 8A, the UE may implement the TDD scheme 44₁ or the TDD scheme 44₂ that were described in connection with FIG. 7A. Especially in connection with the mixed slots 34 of TDD scheme 44₂, in Mode 2, the relay device 70 may be configured for mapping information 42₁ to 42₁₀ to a common frequency block 46 which may result in a comparatively large continuous block 48 of unused resources by relay device 70 which may allow for a high degree of freedom to use those unused resources for different purposes.

Referring now to FIG. 8B, such a result of information 42₁ to 42₆ may also be done in downlink, e.g., in Mode 2 FDD with time to frequency shift.

That is, the relay device 70 is illustrated to perform the mapping of the receive signal 12 to the transmit signal 14. Such a mapping may be managed via a given relay node which receives the corresponding data and control from a controlling entity such as a terrestrial network, TN, base station, e.g., a gNB. Therefore, the UE 20 may configure the relay node 70 or send a request to the network which takes over the configuration of the relay device 70 accordingly. This means there can be at least three ways of control, the UE-controlled relay device, the network controlled relay device or a cell controlled relay device, e.g., operating autonomously. Such a mode can be static or may be changed dynamically. For example, a relay device such as relay device 60 or 70 may operate in an autonomous mode of operation in absence of control via a base station. Alternatively or in addition, such a relay device may be configured to accept a control from a UE based on or dependent from a qualification or authorization of the base station or a network controlling entity. Other ways of switching between said operation modes may be implemented without deviating from the described embodiments.

As a result, a device such as the UE 20 may communicate with the relay device 70, according to one embodiment, only while the data link is managed in a transparent manner. The at least one relay node 70 of the wireless communication network 700 may be implemented in a fixed or mobile fashion, mounted to buildings, street furniture, uncrewed aerial vehicles, UAVs, autonomous guided vehicles, AGVs, or the like.

At least some discriminating aspects of such solutions when compared to known concepts is a TDD/FDD conversion on an amplify and forward, digitize and forward and store and/or forward basis to allow for the addition of an outer code for reliability enhancement combined with a synchronized playout of data through an unsynchronized data transmission network. Only the relays device may be required to know the resources and their time behaviour and the satellite network can be optimized regarding throughput. For this the whole relay network is synchronized via satellite (either directly or by use of an external clock such as a navigation system like GPS)

### Relay Operation

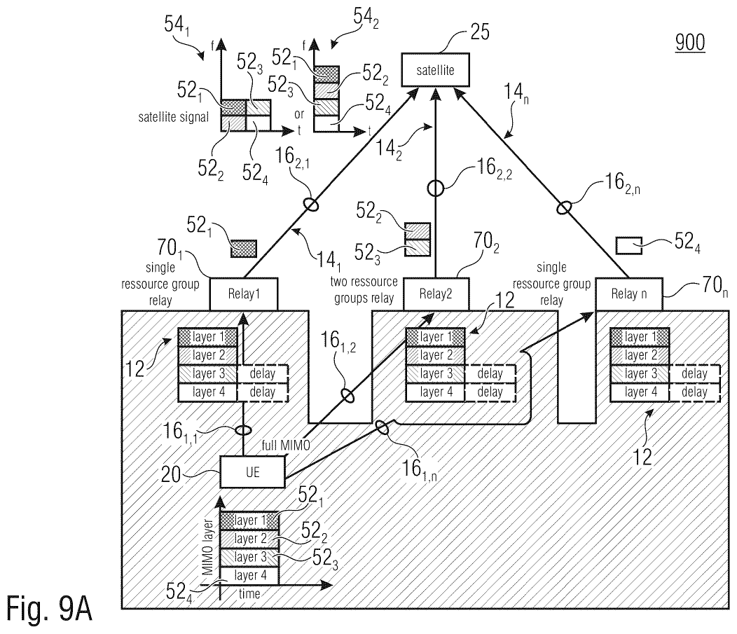

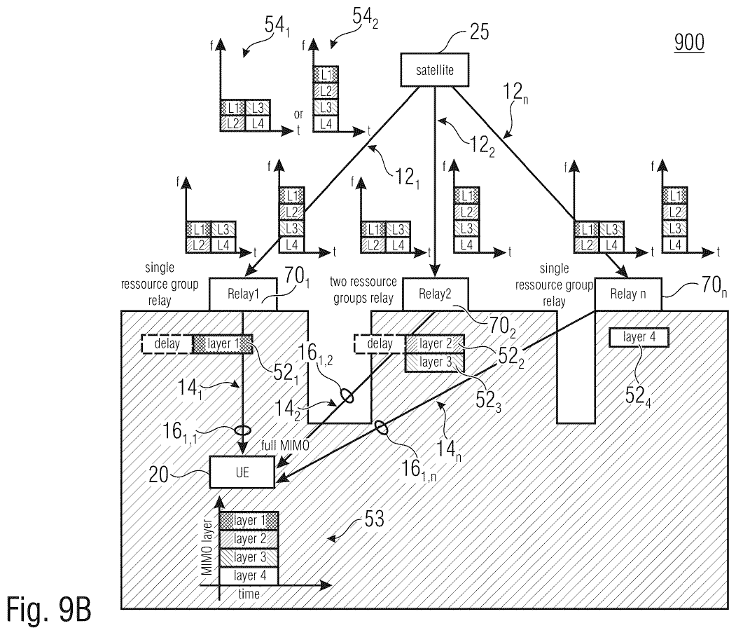

FIG. 9A-B illustrate a further improvement wherein the UE 20 is capable of making simultaneous use of multiple relays 70₁ to 70ₙ with n>1. This relies on the UE 20 being capable of configuring the relays 70₁ to 70ₙ or alternatively or in addition the gNB could also configure the relays 70₁ to 70ₙ. This could be initiated either by the UE 20 or by the not illustrated gNB (either directly or via the other partner in the communication). The relaying communication can include an also not illustrated direct UE/gNB link but this is not mandatory. Alternatively this link could even be realized via a terrestrial BS, e.g., using a split of control path and data path. Besides splitting data and control over the TN and NTN links, data which needs to be transmitted with lower delays than typically being available in NTN can be transmitted via TN.

In connection with FIGS. 9A-B, embodiments will be described according to which a relay device is presented where the receive signal 12 comprises payload data, wherein the relay device is adapted for relaying only or at least a selected part of the payload data. For example, UE 20 may use a full MIMO transmit strategy to transmit wireless receive signal 12 to the relay devices 70₁ to 70ₙ, e.g., using respective links 16₁, and by using MIMO layers 52₁ to 52ₙ, wherein, for example, four layers are presented, wherein the number four is not limiting in connection with the present embodiments. Relay 70₁ may be configured for selecting a single resource group, e.g., layer 52₁ for being forwarded with transmit signal 14₁ over link 16_{2,1}. A different relay such as relay device 70₂ may be configured for selecting different groups of resources and/or a different number of resources such as at least two layers 52₂ and 52₃ for being part of the transmit signal 14₂, possibly omitting the layers 52₁ and 52₄. A link 16_{2,2} between the relay device 70₂ and the satellite 25 may be used for transmitting transmit signal 14₂. Relay device 70ₙ may select layer 52₄ for being a part of a wireless transmit signal 14ₙ transmitted over link 16_{2,n} to satellite 25.

The relay devices 70₁ to 70ₙ may operate in a coordinated manner such that the groups of resources 52₁ to 52₄ arrive at the satellite 25 according to a predefined signal scheme 54₁ or 54₂. That is, by use of the wireless transmit signals 14₁ to 14ₙ, a respective shift in time and/or frequency with respect to one another may be implemented.

Selection of the part may be based on a decision made at the relay device 70 and/or a configuration of the relay device based on a decision made at the configuring device. The selected part may be or may comprise
a part of the payload;
the complete payload;
an incremental replica of at least a part of the payload;
multiple redundant copies including full and partial redundancy;
Combinations of the above

In view of such a selection, it is possible to deriving a derivate from the selected part of the payload. For example, in knowledge of available resources at the link 16₂ the relay device may encode or additionally encode the payload data, e.g., to make the payload more robust for errors. Alternatively or in addition, incremental replicas may be derived and the respective subsequent increments may be transmitted in later signals, there occurring as a derivate of a former or previous receive signal. Accordingly, embodiments provide relate to a receive signal that comprises payload data; wherein the relay device is adapted to relaying a derivate of at least a part of the payload data. For example, the derivate comprises an encoded version of the payload, an incremental replica of at least a part of the payload and/or a copy of at least a part of the payload.

FIG. 9B shows a schematic block diagram of the wireless communication network 900 being illustrated in FIG. 9A for a downlink scenario whilst FIG. 9A relates to an uplink scenario. The relay devices 70₁ to 70ₙ may operate according to a predefined signal scheme 54₁ or 54₂ to select the respective portions of the receive signals 12₁ to 12ₙ such that selected portions, e.g., different layers 52 overlap at the UE according to MIMO scheme 53 to allow a proper decoding and/or reception of the overall signal. The relay devices 70₁ to 70ₙ may be adapted to select the selected part in either direction towards the UE 20 or the satellite 25 based on a transmission criterion such as a delay/latency requirement, a quality of service or a channel criterion, e.g., to select different parts for different frequency-selective channels that behave differently over the overall frequency range.

The relay devices 70₁ to 70₃ may be adapted to jointly operate in a synchronized manner, wherein at least one further relay forwards at least a part of a remaining part of the payload data.

The relay devices 70₁ to 70ₙ may be adapted for receiving the selection information, e.g., which part of the received signal and/or from which signal the relaying shall be performed and for selecting the selected part based on the selection information. Such a selection information may be received, for example from a base station or from a device transmitting the receive signal. Alternatively or in addition, the relay device may select the selected part based on autonomous operation, e.g., selecting the best part of the signal or the like.

For the terrestrial frequency band, the relays 70₁ to 70ₙ may incorporate any number of antennas to be able to fully receive the terrestrial MIMO signal. At least tow, a group or all participating relays may be synchronized and be configured in regard to resources on the UE-relay link 16₁ and also the relay-satellite 16₂ link. The relays may be utilized as follows.

In the uplink, see FIG. 9A, each relay device 70₁ to 70ₙ, referred to as rely device 70 may be configured to forward only certain resources of the overall stream (frequency, time resources). The relay device may frequency convert the user signal to a higher frequency, potentially by amplify and forward, digitize and forward or decode and forward. The relay device 70 may also store the received data for later transmission or to adapt it to a certain frequency/time-scheme (e.g. for 2×2 MIMO, 2 frequency blocks and 2 time slots for a single polarization satellite) or potentially multiple times.

The data received by a relay device 70 may also be applied with a different modulation and a different code for the satellite link 16₂ taking into account unused frequency/time resources in the satellite uplink band.

This data is transmitted at a different frequency/time resource in the satellite frequency band. Here the data may also contain resource blocks/spatial streams with information that is used to configure the relay device 70 but is not relayed to the satellite. This data is advantageously decodable by the relay when contained in the signal. A further relay device 70 may be configured to receive different resource blocks from the UE and will relay these similarly like the first relay device 70 but to a different frequency/polarization on the satellite frequency band. This may be synchronous to the received signal but may also diverge. By this a spatial and time separated information is transmitted in a frequency, time and polarization diverse way.

In the downlink, see FIG. 9B, each relay device 70 may be configured to forward only certain resources in frequency, polarization and/or time which are transmitted to the relay device 70 from the satellite 25, which may also include beamforming/spatial multiplexing towards the relay and the like. The relay device 70 then frequency converts the gNB signal to the UE's frequency, potentially by amplify and forward or by digitize and forward. The relay device 70 may also store the received data to transmit it later, potentially multiple times. The received data may also be decoded containing the UE transmit signal and potentially an additional control signal to the relay device 70 that is not forwarded to the UE 20, e.g., relaying playout time-instant information or the like. The UE signal 14₁ to 14ₙ then is transmitted at a different frequency/time resource in the UE frequency band. A further relay device 70 may be configured to receive different resource blocks from the gNB via satellite 25 and will relay these similarly like the first relay converting it to the same frequency and transmitting at the same time. Through this, spatially-separated information is generated from a frequency diverse distributed signal. That is, according to an embodiment, a relay device may be configured for relaying according to at least one of: an amplify and forward relaying; a digitize and forward relaying; and a store and forward relaying.

As another benefit, relay device 70 may be used to increase the MIMO-rank by adding “deterministic multi-path” signals instead of the line-of-sight, LOS-dominated direct link from the NTN to the UE 20. Position information of relay nodes, transmit direction-of-arrival-DoA, other transmit key performance indicators, KPIs (powers, TDD/FDD grid, . . . ) may be obtained from the location management function, LMF, other higher layer functions or from gNB. In other words, FIG. 9A-B show an example of an embodied spatial stream to frequency conversion with full MIMO. At least one MIMO layer of the UE 20 is allocated to each of the NTN-capable relays 70₁ to 70ₙ in uplink, see FIG. 9A and downlink, see FIG. 9B. As indicated by the label “delay”, at least some parts some parts of a signal, especially in link 16₁ between the UE and the relay may be subject to or tolerant for a delay. For example, delay label may be understood that the respective layer is potentially delayed, e.g., due to a store and forward relaying and to be transmitted at a later point in time.

For example, signal scheme 54₁ may show the partly delayed transmitted signal for layers 52₃ and 52₄, while signal scheme 54₂ may show the not delayed, only frequency converted signal. On the receive path shown in FIG. 9B the label delay may be understood as to align the layers so they are all transmitted at the same time. It should be understood that such a delay may also be inserted intentionally. For example, the relay device may be aware, e.g., by signal decoding or instructions received, about parts of the signal that may allow additional delay or may cope with additional delay. In case of a scenario where limited resources on the link of the wireless transmit signal the relay may select urgent parts of the signal to be transmitted immediately or at least prior to parts, e.g., layers 52₃ and 544 that may be delayed, e.g., based on loosened time requirements.

Enhanced MIMO relay

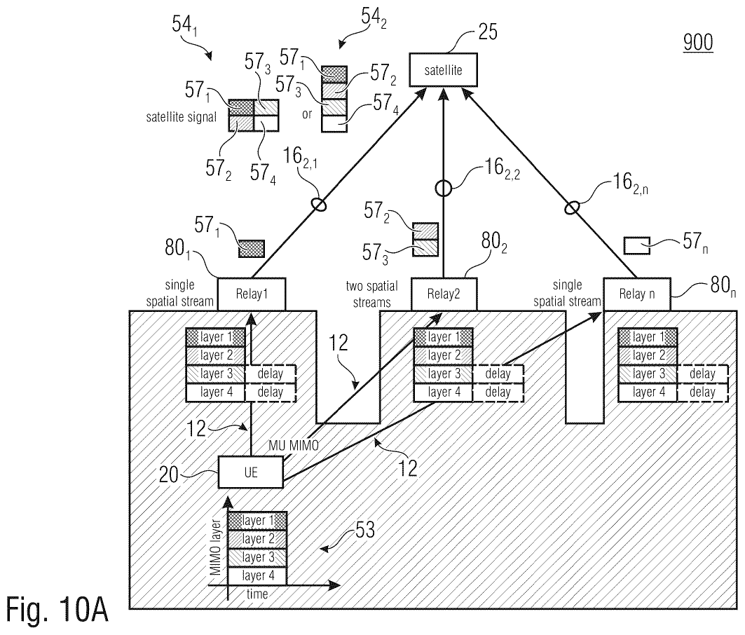

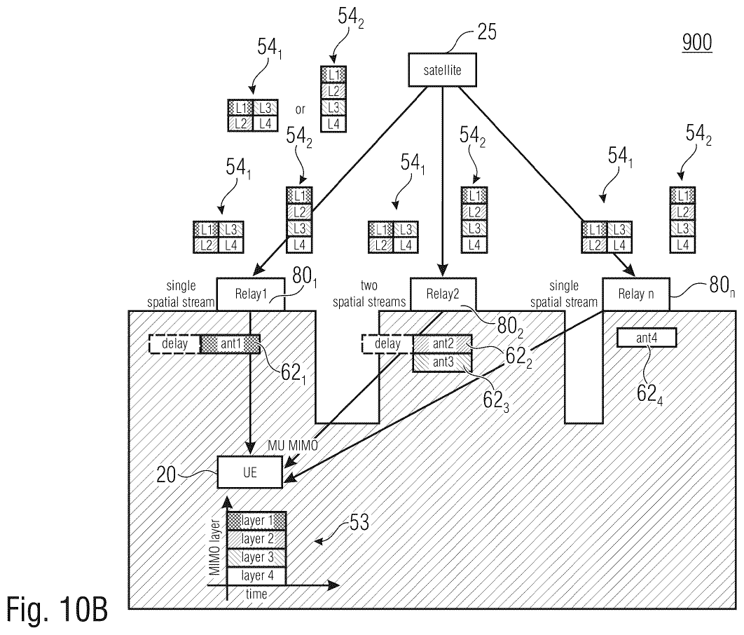

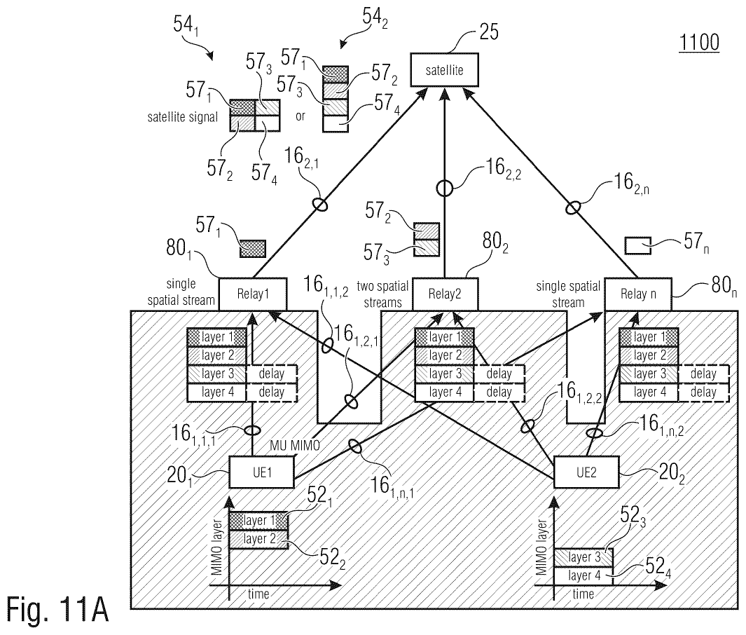

FIG. 10A-B illustrate a further variant in which the MIMO capabilities of the overall system 900 are enhanced by allowing a distributed MIMO precoding over all the available transceivers/relay devices 80₁ to 80ₙ so that they act like a single MIMO antenna array for the UE 20, the layers may the be aggregated for the satellite 25. For example, by using macro diversity precoding the Eigenvalue matrix can be forced to have full rank and is able to avoid keyhole effects. In FIG. 10A, the relay devices 80₁ to 80ₙ may use different spatial streams, e.g., by using selected antenna ports or antennas (ANT) 62 and/or beams to transmit different layers (L).

The relay devices 80₁ to 80ₙ may be similar to the relay devices 60 and/or 70, wherein each of the relay devices may use a spatial stream for each part 571 to 57n of the wireless receive signal 12 it relays. It is to be noted that although the relays 70 and/or the relays 80 may possibly receive the same signal and select a part thereof to be forwarded, e.g., by using respective time frequency resources in FIG. 9A-B and/or by using spatial resources as in FIG. 10A-B, the UE may instead or in addition provide for individual signals to different relays. Although such a transmission of separated signals may be intransparent for the UE it may nevertheless allow to increase throughput to or from the satellite.

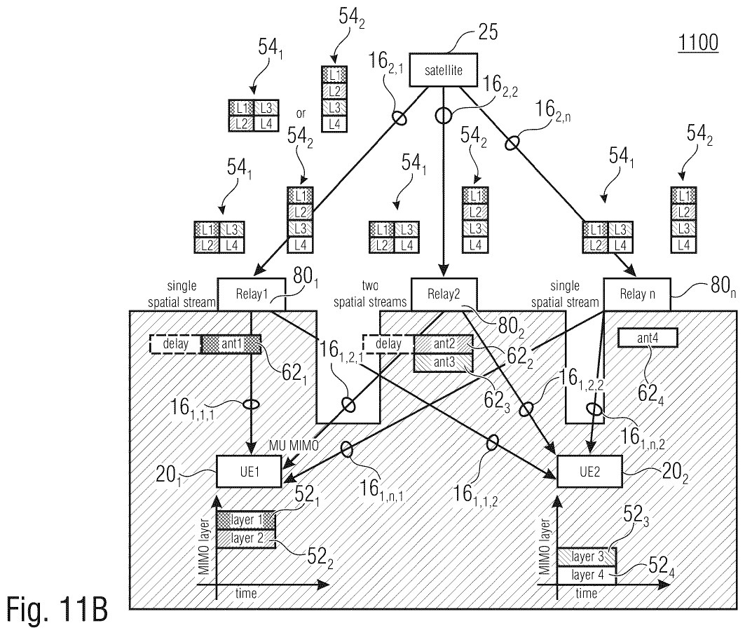

Yet another variant is shown in FIG. 11A-B in accordance with embodiments is to utilize the relays in a Multiuser MIMO like way. By this each relay 80 possibly receives not all spatial streams or layers but only a subset that are based, e.g., on orthogonal Eigenspace weights. These streams are treated as in the full MIMO example of FIG. 9A-B and are forwarded to the satellite 25, e.g., in an FDD manner or received from the satellite 25 in this way.

As may be seen from FIG. 11A in the uplink and from FIG. 11B in the downlink, a relay device 80 may be configured for also not relaying a signal. For example, relay 80₁ may decide to not forward 52₃ and/or 52₄ used by a further UE 20₂, e.g., as the signal is associated with a too long delay and/or an amplitude below a threshold or a different criterion. Alternatively or in addition, relay 80ₙ may decide or be controlled to not forward layers 52₁ and/or 52₂ used by UE 20₁ for the same or a different reason. Relay 80₂ that may be aware of both transmissions from UE 20₁ and 20₂ may select layers 52₂ and 52₃ from different UEs to be commonly forwarded whilst dismissing parts 52₁ and/or 52₄ based on the joint operation.

In FIG. 11B a singular decision or control may be implemented for the relay devices 80₁ to 80ₙ to use respective antennas or antenna ports to provide for the parts 52₁ and 52₂ on the one hand and 52₃ and 52₄ on the other hand at the respective UE 20₁ and 20₂ whilst possibly avoiding interference by other parts.

This variant can be utilized to enable relays to transmit data from two different UEs at the same time. In uplink, each relay sees all resources associated with it and transmits the configured resources. In downlink, see FIG. 11B, each UE 20₁ and 20₂ may receive all resources but uses only the ones associated with it. The benefit of this solution is that spatial separation can be introduced on the UE-relay link 16₁ and relay-satellite links 16_{2,1} to 16_{2,n} enhancing the MIMO capabilities of the overall system.

At least some of the discriminating aspects of this solution when compared to known systems are: Relaying of signals from multiple UEs 20ᵢ with i>1 through a single relay 80 allowing a fully distributed layer of relays 80₁ to 80ₙ which may also be mobile and are able to provide full MIMO capabilities transparently over a satellite link. The MIMO configuration may be centrally optimized for end to end communication or only on the ground segment.

### Relay Node Configuration

A relay node configuration of a relay 60, 70 and/or 80 may include but is not limited to:
Available resources on UE-relay link 16₁ and relay-satellite link 16₂ (may be updated, e.g., based on a trigger, regularly or on demand).
UE-relay association (which UE may use a certain relay, including white and blacklisting)
Relay-satellite/UAV association (which satellites may be received/transmitted to, including satellite position/time information, e.g. based on system information block SIB19 (5G NR) and SIB31 (LTE))
A relay-satellite/UAV network association
An operational area, coverage area or connectivity area (e.g. geo-fencing for mobile relays) and their basic configuration (e.g. list of frequency bands for different countries)
an opportunity/availability for communication of the link.
An operational parameter such as one or more of a list of frequency bands, allowed transmission powers, MIMO Modes and the like
A synchronization source such as GPS, local sync source, further relay with master clock and the like
A relay software version or availability such as an update over the air

Some, a set or all of the information may be transmitted to a relay according to an embodiment with a configuration signal which may be an independent or dedicated signal at least in parts incorporated in a signals such as a signal to be forwarded or that configured a cell in which the UE is operated. A relay device according to an embodiment may be configured for receiving a configuration signal indicating some or all of the configuration parameters for the relay node configuration and for operating accordingly. Such a signal may be received, for example, from a base station such as a gNB, from the UE and/or a supervising entity such as a network controller or a central entity.

### Relay Node Capabilities and Associated Capability Signalling

Relay node capabilities and associated capability signalling from the relay to the network to inform the network about the capability may include at least one of but not limited to:
A number of antennas and type of antennas;
A supported transmit power;
A supported number of frequency bands and associated bandwidths and subcarrier spacing;
A supported number of MIMO layers on UE side;
Information indicating electrical limits of the relay such as a battery status;
A synchronization state or capability such as an RRC state;
Available resources, e.g., for at least one of the supported links, e.g., terrestrial and/or satellite;
A mobility property or parameter, speed and/or position;
A temporal availability of the relay device;
A satellite signal quality, e.g., as part of CSI feedback;
A ground segment signal quality, e.g., as part of CSI feedback;
An owner, provider and/or operator of the relay device;
A relaying group having at least two relays, e.g., when using the group of relays commonly e.g., on a train or ship;
A supported processing time, e.g., relevant for TDD/FDD transfer;
a battery state or power indicator, e.g. remaining battery lifetime, battery charging information. For example in terms of a percentage, a recharge rate in case of solar and the like.

A relay according to an embodiment may have a relaying capability to relay signals. The relay device may be configured to transmit a capability information related to the relaying capability. A relay device according to an embodiment may be configured for transmitting a capability signal comprising information indicating some or all of the parameters mentioned in connection with the relay node capability. Such a signal may be received, for example, to a base station such as a gNB, from the UE and/or a supervising entity such as a network controller or a central entity. The wireless communication network may be configured for controlling a use, a usability or availability of one or more relay devices accordingly, e.g., to use a set of relay devices in a coordinated or synchronised manner. This may relate to a synchronised operation as described in connection with FIG. 9A-B, FIG. 10A-B and/or FIG. 11A-B but also to a scenario where different relay devices are intentionally configured differently to provide different types of service and/to optimise for different criteria with different sets of relay nodes, the sets operating an overlapping or same coverage area or different coverage areas. Such a synchronised manner may relate to a tight synchronisation, e.g., as a precise as possible but also to a loose synchronisation, e.g., to allow a repetition or other transmission with a random delay of a predefined and known maximum.

### Detection and Signalling of Relays

Detection and signalling of relays available and/or active in an end-to-end, e2e, communication path may include one or more of but are not limited to:
Broadcast channel for relay detection (request by UE to detect inactive relays).
Beacon from relays for easy detection by UE, (e.g. kind of an notification/alert channel by the relay, containing at least part of the relay capabilities listed in chapter 4.3).
Relay location map provided via terr broadcast or direct satlink to UE, optionally including the temporal availability of the relays)

A device according to an embodiment, e.g., a UE, a relay device, a base station or a satellite may be configured for a detection signal indicating information associated with a recognised or detected relay device to other devices or the wireless communication network to enhance propagation of a respective knowledge. A relay device according to an embodiment may use the described detection mechanism to announce itself to the wireless communication network either directly or to be recognised by another device that reports about the detection of the relay device.

### Relaying Procedure and Related Signalling

Relaying procedure and related signalling, e.g., to control the relay device or a different device, may include at least one of but are not limited to:
Discovery process
   UE-relay, e.g. a user to network, U2N, and/or user to user, U2U, relay
   Relay-satellite or UAV
   Relay-Relay, e.g., in case of multi-hop
   The individual discovery processes can be independent
e2e Attachment/Detachment process UE-“one or multiple relays”-satellite including configurations like RRC configurations in 4G and 5G from network to UE,
Initialization of relaying link, e.g., configuration setup of Relay, like for network controlled repeaters according to work item description, WID, in RP-230175 and/or in Sidelink U2U Relaying or Sidelink U2N Relaying
SISO/MIMO to MU-MIMO configuration change
Optimization of MU-MIMO relaying
Continuous updates of capabilities and signalling of repeaters in case of mobile relays or stationary relays which are not available all the time

According to an embodiment, a wireless communication network such as network 600, 700, 900 and/or 1100 may comprise at least one relay device described herein; and a first and second device using the relay device for relaying a signal between the first device and the second device, e.g., devices 10₁ and 10₂ or devices 20 and 25. The wireless communication network may be adapted for at least one of:
a discovery process for discovering the relay device;
an attachment/detachment process of a relay device to a link operated by at least one of the first and second device;
an initialisation of a relaying operation of the relay device;
a change of configuration of the relay device;
an update procedure for updating the relay device.

Embodiments further provide for a base station configured for operating a link with a relay device described herein.

Embodiments further provide for a device such as a user equipment, configured for operating a link with a relay device described herein.

Embodiments provide a wireless communication system comprising such a base station and such a device in connection with a relay device described herein that is configured for relaying a signal between the base station and the device.

The wireless communication network may comprise a plurality of relay devices and may coordinate the plurality of relay devices for a joint operation for relaying signals to or from a common device. For example, the joint operation relates to controlling the plurality of relay devices to only forward a part of the receive signal; wherein the plurality of relay devices forwards a complete payload of the receive signal, see FIG. 10A-B and FIG. 11A-B. For example, the control data or other non-payload may be removed from the wireless transmit signal(s) as described above.

The invention provides advantages for multiple instances of a wireless communication network. For example, on a UE side, the UE may benefit from less power needed for satellite communication, e.g., as it only requires to reach the relay. The UE may be released from supporting NTN features as the relay may take care of some or even all parts of a satellite (NTN) protocol. Alternatively or in addition, a UE may not be required to have a mmWave (FR2) modem, even if a satellite link is in the frequency range as this is handled by the relay. Further, the UE may support FR2 communication or even higher frequencies by a dense deployment of relay nodes in the proximity of the UE.

The overall network may benefit from higher reliability and/or higher data rates. This may be based on the assumption that a satellite channel is almost always a LOS path. Alternatively or in addition, the relay can use more transmission power than a UE. Alternatively or in addition, a benefit may be made as a relay may be equipped with better antennas than a UE, e.g., due to cost criteria and electromagnetic compatibility, EMC, requirements. Alternatively or in addition, higher data rates may be supported due to higher transmission power and better antennas, leading to a better or even optimum MODCOD (modulation and coding) over satellite. Further, a higher order MIMO constellation may be transmitted over satellite that only has one antenna per polarization.

The overall network may further benefit in view of a simple distributed infrastructure. Relays may be operator independent. Devices may be resilient to failures of single units and the concept can be extended to a terrestrial relaying network.

It is to be noted that a UE-relay link although being descried in connection with some embodiments as employing TDD is not required to be operated accordingly. Alternatively or in addition, such a link may also be operated in FDD.

The invention may be used in wireless communication networks, for example, in specific scenarios such as a disaster recovery scenario where the optimization of a satellite only network is required as it may be easier to set up a bunch of relays than a base station, especially if no terrestrial backhaul is available. Embodiments of the present invention may further be used to offload data traffic to satellites in densely populated areas and/or for offloading of data for a campus large, potentially remote campus networks such as an oil rig and/or a cruise ship.

Depending on the implementation of the satellite network, parts of the management functionality are located in the relay or base station instead of a core network, e.g. an AMF or location/positioning services. The AMF might be required to be executed locally to support routing of traffic, while location services benefit from lower latency.

With regards to a device such as a UE described herein, e.g., the UE 20 of FIG. 9A-B, FIG. 10A-B, and/or FIG. 11A-B, a device according to an embodiment is configured for utilizing a wireless communication link that comprises a relay device for relaying a wireless signal towards or from the device, wherein the device is configured for providing a selection information indicating a part of a payload data to be forwarded by the relay device; and/or wherein the device is configured for receiving a plurality of relayed signals from a corresponding plurality of relay devices; the plurality of payload data being associated with a same signal source that has transmitted the plurality of payload data with a same signal.

With regard to the functionality of relaying described, e.g., in connection with relay devices, some of the described devices may receive a wireless signal, the wireless receive signal, and may actively form, generate and transmit a different wireless signal, the wireless transmit signal. Thus a different signal may be transmitted when compared to the received signal. However, the same or a modified message, e.g., modified in view of time-to-live, hop-count, origin of the signal and the like, is contained in the wireless transmit signal when compared to the wireless receive signal such that the concept of relying a signal is not necessarily linked to transmitting the same signal although not excluding such an option. Embodiments referring to relaying of a signal thus relate to receiving the wireless receive signal and to transmit transmitting the wireless transmit signal based thereon and with a same or modified message contained therein.

Further advantageous embodiments with regard to the operation of relays and possibilities to make use thereof are described below.

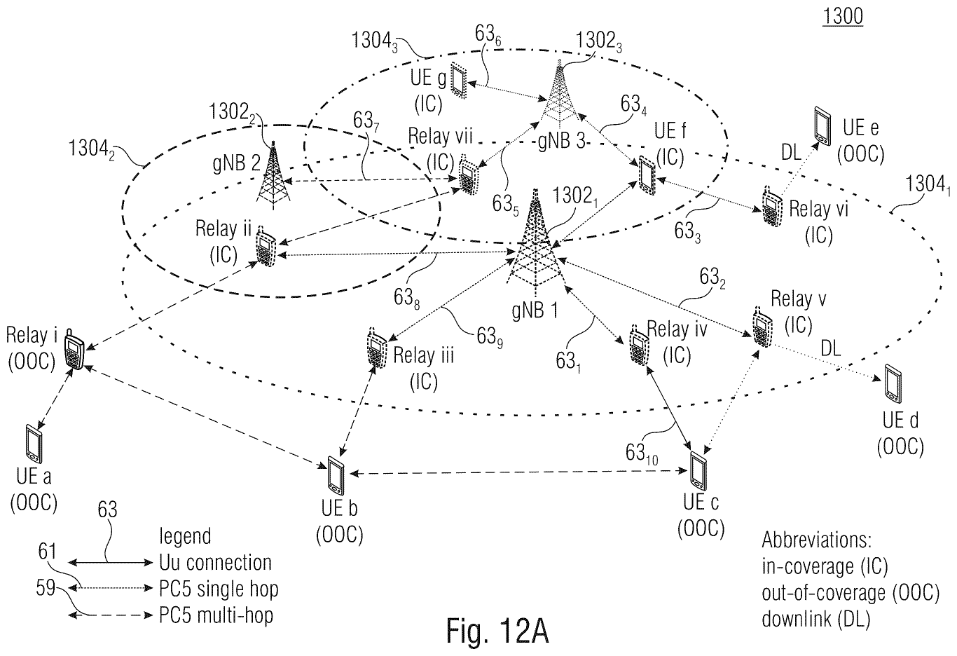

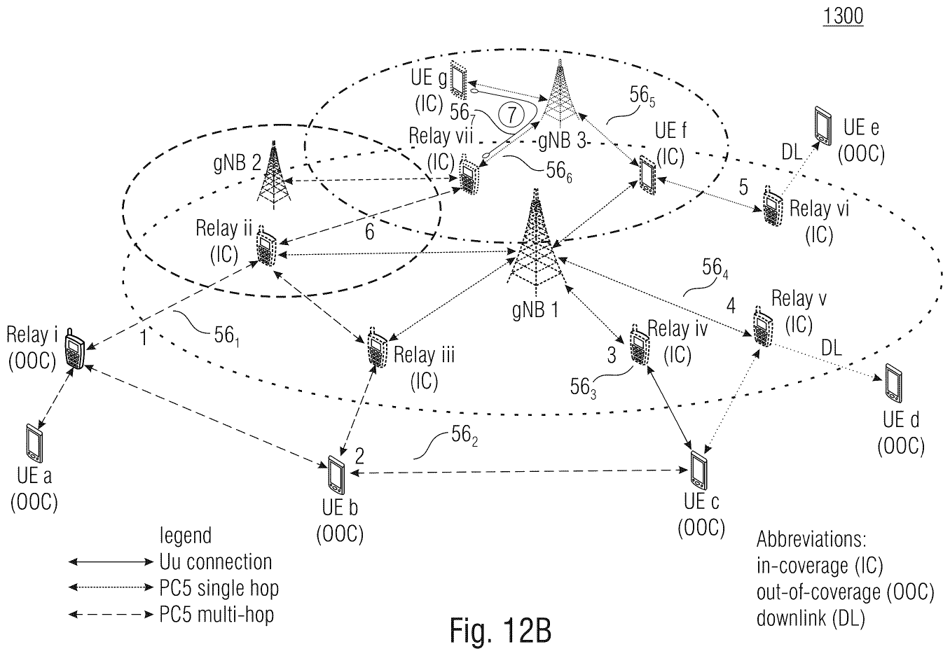

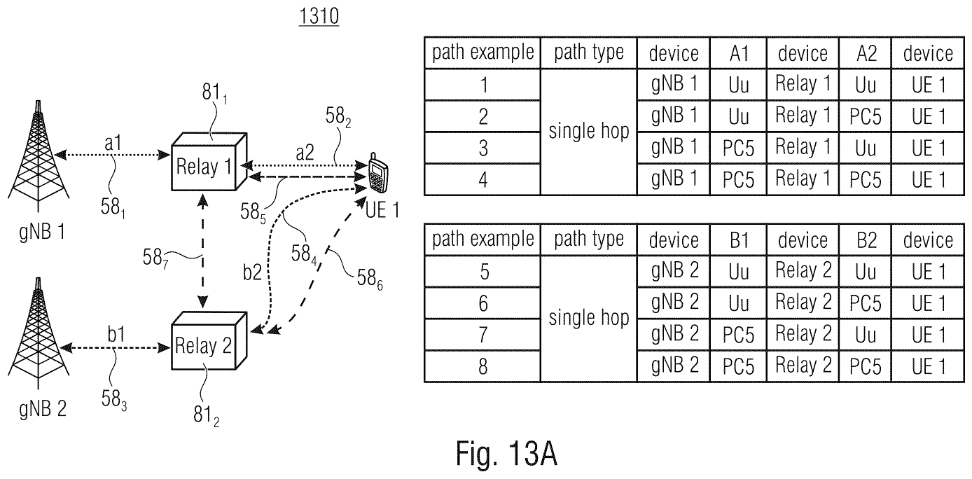

FIG. 12A shows a schematic block diagram of a wireless communication network 1300 according to an embodiment. Wireless communication network 1300 may comprise several base stations 1302₁, 1302₂ and 1302₃ providing service in different coverage areas 1304₁, 1304₂ and 1304₃, respectively. Devices such as UEs within one or more coverage areas 1304₁, 1304₂ and 1304₃, respectively, are considered to be in-coverage, IC. Relay devices i through vii may be in accordance with a relay device described herein, i.e., a relay device according to an embodiment.

With reference to FIG. 12A there is shown the concept of different paths in a wireless communication network.

Different UEs as are located in the wireless communication network 1300, some of the UEs being located within the coverage area 1304₁ to 1304₃, i.e., they may be in coverage, IC, and some of them outside thereof, i.e., out of coverage, OOC. UEs may be operated, at least temporarily as a relay device described herein such as relay device described herein.

To different UEs such as remote UEs UE a, UE b, UE c or UE d there may be provided paths, each path having one or more path segments, wherein each path segment may be established by at least one of a Uu connection 63, a PC5 single hop connection 61 or a hop of a PC5 multi-hop connection 59. As may be seen, e.g. with regard to UE c a UE may be reached via different paths. It may therefore be of benefit when selecting at least a path segment towards a specific target, wherein such a selection may be implemented based on varying conditions such as varying positions, load scenarios, quality requirements or the like.

Embodiments, thus, relate to distributing information about links, paths or path segments within the network to a deciding entity, wherein such a deciding entity may be a central controller, may be located at a base station such as gNB, at a relay device, at a device being a source for a signal to be transmitted and/or a device being a sync of such a signal.

As may be seen from FIG. 12A, a device such as a relay device may operate a single path segment, see relay iv₁, may operate two path segments of a same or different paths, see relay device v or relay device iii or may operate more than a single path and an increased number of path segments.

In other words, during the discovery phase a relay UE or relay device may answer discovery messages and include further information, alter, add or fuse (combine) path properties, beam IDs, frequency shifts, jitter, geolocation, relative location or distance. When sending the answer back the multi-hop chain, the same principle applies to the response message as for the discovery message. The gNodeB (base station) at the end then has a response with a branch ID and associated properties.

The path ID can be used by the remote UE to send the message on a specific path that matches the QoS requirements and/or supported feature set. The gNodeB can also use the path ID to schedule the downlink transmission back to the remote UE.

This way, the relay UEs do only need limited intelligence to do the routing, which only based on the discovery outcome and the resulting path ID/destination pairs.

### Procedure:

Remote a UE may send out discovery message. The discovery message is received by relay devices that send out a discovery message as well to find a path to the base station (if they don't already have a Uu connection/can establish a Uu connection). If a relay device already has multiple uplink-heavy remote UEs to relay it may decide to not transmitting an answer.

Finally two (or more) paths may be established and the response message will go back the path until it reaches the requesting UE that now has two relay/path candidates.

On another bearer for another service, the gNodeB is looking for a specific UE and tries to discover the UE via connected relay UEs. Some relays devices can reach the UE, but so can, e.g., a relay device which is now answering the discovery, because there is downlink capacity. The gNodeB has the option to choose the ‘best’ connection out of three, whereas the remote UE only has two options.

Alternative routing options can be monitored but do not have to be active. They can be used as fallback in case of RLF on the other route. Also, conditional handover or re-configuration is possible in case the properties of one path do no longer meet the requirements.

According to embodiments, a device maintaining a direct connection to a base station may use a Uu connection 63. A relay device relaying a wireless receive signal may use a single hop PC5 connection 61 or a PC5 multi-hop connection 59 for relaying. However, as shown, for example, for relay iv which may be a user equipment, UE or a different entity, may establish a Uu connection with a user equipment, e.g., UE c of the wireless communication network and for relaying the wireless receive signal to or from the user equipment UE c. Although using a Uu connection between relay iv and UE c may be used regardless whether UE c in-coverage or out-of-coverage, OOC, and regardless whether the signal is transmitted in uplink UL, or in downlink, DL, using a Uu connection 63₁₀ between relay iv and UE c may be of advantage when providing, at least in parts, a base station functionality for UE c by relay iv. For example, relay device iv may, in accordance with embodiments, provide at least a part of an access and mobility management function, AMF, and/or a location management function, LMF, for devices that are connected with the relay. Such a mechanism may be used, as an alternative or in addition, in a case where relay device iv misses a backhaul link. Alternatively or in addition, devices may benefit from such a mechanism when being operated as a receiver of the wireless transmit signal in a different network when compared to a source of the wireless receive signal.

In yet another advantageous modification, the relay device iv may use any 3GPP connection, or a non-3GPP connection such as a Bluetooth connection, a LiFi connetion and/or a WIFI connection to connect to the gNB 1302₁ or UE c.

According to such an implementation, the relay device may maintain even two or more Uu connections to different devices, wherein one or more or even none of them may be a base station whilst the other is, for example, a UE or a different relay device. For example, relay i may, in some cases, decide to use Uu connections for UE a or UE b as well as for connecting to relay ii. This allows the relay device to establish two or more Uu connections and to maintain them simultaneously and for relaying wireless receive signals using two or more Uu connections.

In a different operation mode or in a different configuration/implementation a relay device according to an embodiment may be configured for receiving the wireless receive signal using a first PC5 connection established with a first device and for transmitting the wireless transmit signal, i.e., the relayed signal, using a second PC5 connection established with a second device, e.g., using a PC5 multi-hop connection 59.

The relay device according to an embodiment may establish the two or more PC5 connections with a relay device or a user equipment on the one hand and with a relay device or a user equipment at the other end. For example, the relay device may relay signals or messages between a user equipment and a relay device, between two relay devices or between two user equipment.

According to an embodiment, a relay device is provided that operates, at least in one relay mode, to simultaneously relay signals or messages in uplink and downlink. In yet another relay mode, a relay in accordance with an embodiment may be configured for simultaneously relaying signals or messages only in one of uplink and downlink, e.g., as part of a multi-TRP configuration. In such a multi-TRP configuration, different devices such as relays may commonly provide a downlink signal for a UE to avoid limitations due to blockage. In uplink for example, different relays may be used to provide for a high reliability of receiving signals.

In other words, FIG. 12A presents a simplified view of a mobile communications network comprised of base stations gNB 1, gNB 2 and gNB 3, user equipment terminals UE a-g and relays i-vii. Although the base stations may provide coverage to many UEs, for reasons of simplicity and visual clarity, the illustration shows only two UEs, i.e., UE f and UE g, as being in-coverage, IC, and 5 UEs UE a, UE b, UE c, UE d and UE e being out-of-coverage, OOC. As the network may include one or more relays, the coverage may be effectively extended so that communication links may be established between all UEs using one or more of the following types of connection: Uu, PC5 single-hop and PC5 multi-hop.

FIG. 12B is identical to FIG. 12A with the exception that examples of paths 561 to 567 from base stations to user equipment devices are shown.

The following may be noted:
not all paths are shown in FIG. 12B but a selection of possible paths;
paths can provide either unidirectional or bidirectional connectivity; and
one or more paths can either originate or terminate at a base station or a UE.

FIG. 12B is illustrates the following path examples:
Path 56₁—from gNB 1 to Relay ii using a Uu connection; and from Relay ii to Relay i to UE a using a PC5 multi-hop connection. The path is fully bidirectional.
Path 56₂—from gNB 1 to Relay iii using a Uu connection; and from Relay iii to UE b to UE c using a PC5 multi-hop connection. UE b acts as a relay. The path is fully bidirectional.
Path 56₃—from gNB 1 to Relay iv using a Uu connection; and from Relay iv to UE c using a PC5 single-hop connection. The path is fully bidirectional.
Path 56₄—from gNB 1 to Relay v using a Uu connection; and from Relay v to UE d using a PC5 single-hop connection. From Relay v to UE d, the path is unidirectional providing downlink only.
Path 56₅—from gNB 3 to UE f to Relay vi using a Uu connection; and from Relay vi to UE e using a single hop connection. UE f acts as a relay. From Relay vi to UE e, the path is unidirectional providing downlink only.
Path 566—from gNB 3 to Relay vii using a Uu connection; from Relay vii to Relay ii to Relay iii to UE b using a PC5 multi-hop connection. The path is fully bidirectional.
Path 56₇—from gNB 2 to Relay vii to gNB 3 using a wireless connection, e.g., a Uu/sidelink, e.g. to establish an Xn interface. The path is fully bidirectional. As an option the path could be extended to connect UE f to gNB 2 via the other entities.

According to an embodiment, one or more relays may be configured for receiving, e.g., from a base station, information indicating a configuration of resources of a sidelink. Such relay devices may be broadcast, groupcast or unicast a resource pool configuration based on the information indicating a configuration of resources of a sidelink. For example, relay vi being IC may receive a signal information block, SIB, and may forward this information via PC5 in broadcast, groupcast or unicast to OOC UE(s), e.g., UEE.

In some embodiments relay devices may also allow to overcome disconnectivity due to an operation of different devices by different mobile network operators. For example, and when referring to FIG. 12A and FIG. 12B, a UE being OOC may discover or see a relay. The UE is, for example, provided with service by a first mobile network operator and the relay device is provided with service by a different second MNO.

Nevertheless, the relay may accept relaying signals and the UE may be adapted to communicate with the relay. This may allow to support a UE that wants to connect to the network via a relay. Usually a relay will not answer the request since it does not belong to the same network/MNO. According to embodiments, this issue is addressed by relaying such signals. One possible part of such a solution is configuring a relay possibly being IC, to receive a system information, SIB, and/or a configuration for a sidelink, SL, pool and to broadcast/groupcast/unicast the resource pool information 21, a group of or all UEs around the relay, e.g., using a sidelink connection, PC5.

This may allow to implement a shared relay being shared between different MNOs.

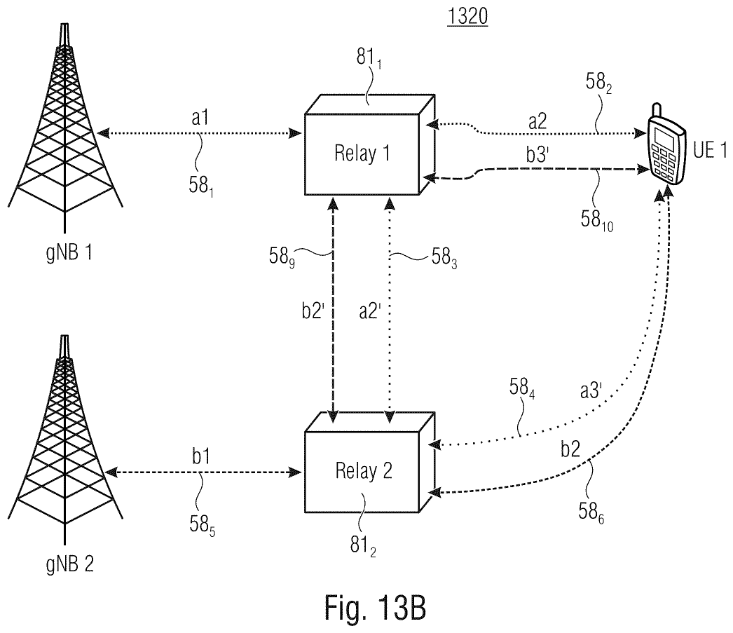

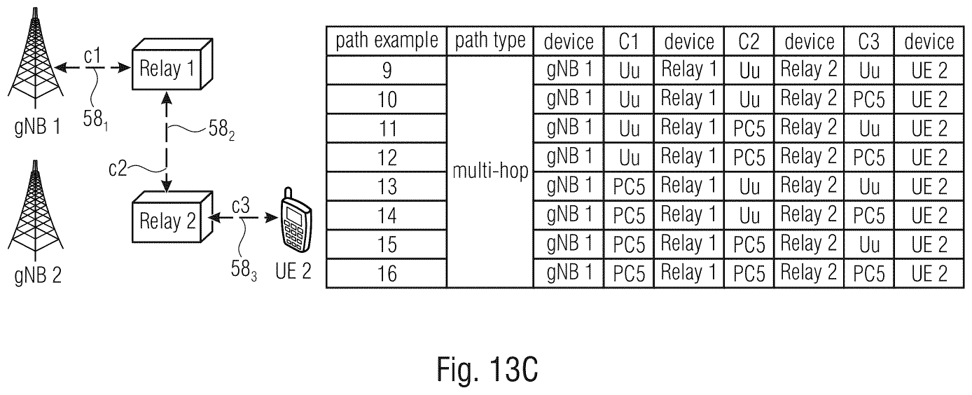

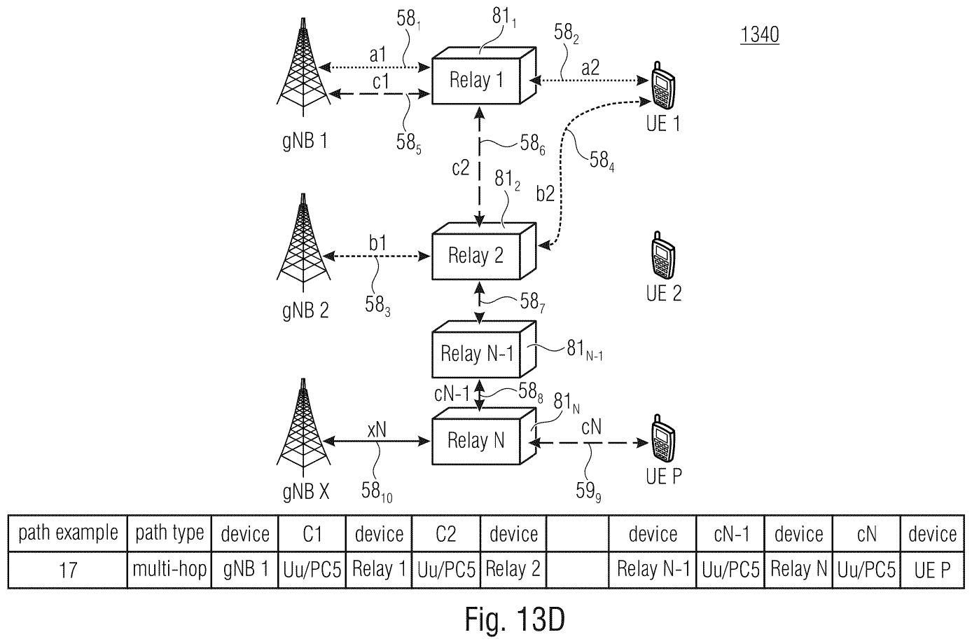

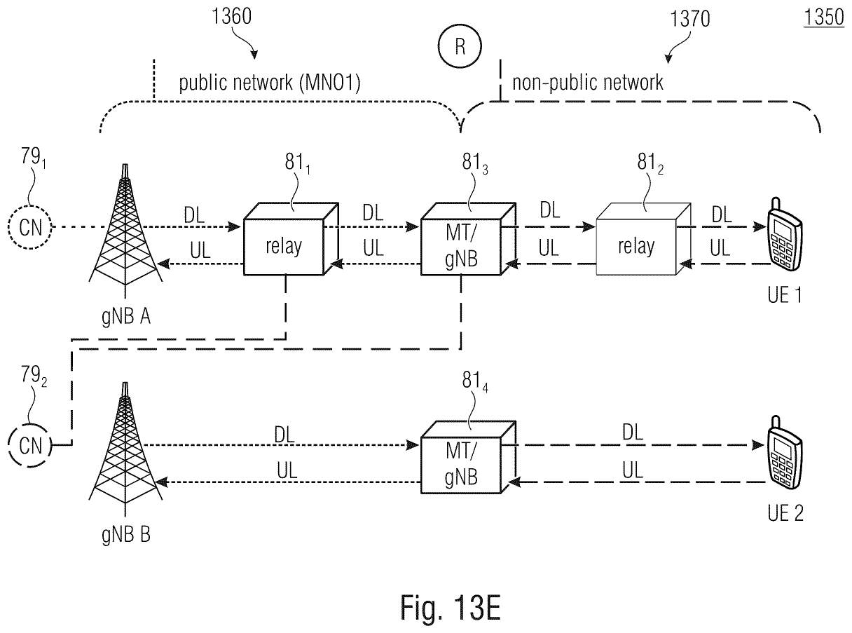

FIG. 13A shows a simplified illustration that shows examples of single-hop connections between two different base stations gNB₁ and gNB₂, two different relays relay 1 labeled as relay 81₁ and relay 2 labeled as relay device 81₂ and a UE₁. Relay device 1 and relay device 2 may be in accordance with an embodiment described herein.

FIG. 13A further shows eight path examples of a single hop connection between gNB 1 and UE 1 using relay 1, between gNB₂ and UE 1 using relay 2 respectively. It may be seen that components 58₁ and 58₂ (A1 and A2) may be established as Uu connection or as PC5 connection each. Same is true for path segments 583 and 584.

In connection with embodiments, reference is made to signals and to messages. For example, a signal may contain a message but may also be interpreted as a sort of message by itself, e.g., by its structure. For example, a Go-To-Sleep may be a signal, the same is true for Wake-Up (−Signals). In another example, paging in 3GPP is usually a message as well as configuration. In connection with embodiments, signal and message may be used as synonyms unless stated otherwise.

A relay device in accordance with embodiments may also operate simultaneously, or time multiplexed in single-hop (solid lines of path segments 58₁, 58₂, 58₃ and 58₄) and/or in multi-hop mode forwarding the messages (dashed lines of path components 58₅, 58₆ or 58₇). Path component 58₇ may be assigned to gNB 1 or MNO 1 or assigned to gNB 2 or MNO 2.

UE can signal capability of supporting single-hop, multi-hop or combinations thereof. In accordance with embodiments,
Device (relay) may support:
   single-hop between
      a UE and a base station
      a UE and another UE
   multi-hop between
      a UE and another relaying device
      a UE and another UE
      another relaying device and further relaying device
      between a relaying device and a base station
   Uni-directional forwarding/relaying
   Bi-directional forwarding/relaying
   Routing capability on at least one of the forwarding links (device can route flows, traffic, packets, messages from one or multiple inputs to one or multiple outputs
   at least one forwarding mode, if multiple forwarding/relaying modes are supported, then:
      Device can be configured into one selected mode
      Device can be configured to switch between modes
      Device can be configured to operate multiple modes concurrently

Thus, the UE itself can support multi-hop as a UE-network, UE to NW, relay or a UE-UE/UE to relay.

FIG. 13B shows a simplified illustration of a wireless communication network 1320 deviating from wireless communication network 1310 of FIG. 13A and showing examples of both single-hop and multi-hop connections between two different base stations gNB1 and gNB2, two different relays relay 1 and relay 2 and UE1.

FIG. 13C shows a schematic block diagram of a wireless communication network 1330 comprising base stations gNB1 and gNB2 in accordance with embodiments, relay 1 and relay 2 being in accordance with embodiments and UE2 being in accordance with embodiments.

FIG. 13C further shows path examples 9-16 using different path components 58₁, 58₂ and 58₃ that may be associated with gNB₁ or gNB₂ each, the respective MNO, respectively.

In other words, FIG. 13C shows the potential multihop relaying path from gNB₁ via Relay1 and Relay2 to UE₂ and vice versa. The type of the actual interconnection link or path segment 58₁ between gNB and Relay1, 58₂ between Relay1 and Relay 2, and 58₃ between Relay 2 and UE can be of a different type as shown in the table of FIG. 13C. In this example the currently known and supported interfaces are Uu and PC5 but also future interfaces may be considered. It is shown that each link is able to support interfaces independent of each other. This also means that the capabilities of the links may be different resulting in a potential different setup/deployment of an overall scenario. Potentially depending on the use case a dynamic switching between the different interfaces may be possible and can result from the movement dynamics of the individual entities in the network.

FIG. 13D shows a simplified illustration of a wireless communication network 1340 according to an embodiment having base stations gNB1, gNB2, . . . , gNBX, several relay devices relay 1, relay 2, relay M−1, relay N and UEs UE1, UE2 and UEP in accordance with embodiments.

Further, a path example 17 is shown indicting that by way of a multi-hop connection different devices up to UE P may be reached whilst each of the respective path components 58₁ to 5810 may be established and/or maintained as a Uu connection or a PC5 connection or a different connection, e.g., a Bluetooth connection or a WIFI connection or a different 3GPP connection.

In other words, the illustration in FIG. 13D shows an example of a combination of single- and multi-hop connections between the UEs and corresponding gNBs. A single-hop connection is established, for example, using path components 58₁ and 58₂, 58₃ and 58₄ respectively. In particular, the data to UE1 can be transmitted from all the gNBs 1,2 and X by using the interfaces between the Relays 2, N−1 and N. To simplify the forwarding it may be beneficial to use same communication protocol in the whole forwarded path. This requires the exchange of capability information in the partial network. In a mixed protocol scenario e.g. PC5, Uu, Bluetooth etc., the relays would have to decode and then forward the information.

Also the network advantageously monitors the link capacity/load (e.g., a resource utilization, a CPU load, . . . ) in order to allow efficient forwarding of messages, e.g., by path selection, throughout the complete routing path.

FIG. 13E shows a schematic block of at least a part of a wireless communication scenario 1350 comprising a first wireless communication network 1360, e.g., a public network operated by MNO1, and a further wireless communication network 1370 being, for example, a different public network or non-public network.

Each of networks 1360 and 1370 may comprise a dedicated core network, CN, 79₁, 79₂, respectively.

Relay devices 81₃ and 81₄ may form a bridge between networks 1360 and 1370. Alternatively or in addition, the relay device 81₃ and 81₄ may be configured for providing at least a part of an access and mobility management function, AMF, and/or location management function, LMF, for one or more devices, e.g., for relay 81₂, UE1, UE2, respectively. For example, such operation may be provided for UE1, UE2 and/or relay 81₂, e.g., if they lack a separate or dedicated backhaul link.

Relay 81₁ may be controlled, for example, by core network 79₁ and/or 79₂. Alternatively or in addition, relay device 81₃ may be controlled by core network 79₁ and/or 79₂. Those relay devices may, thus, form a shared relay device.

A wireless receive signal received by relay device 81₃ or 81₄ from a first wireless communication network 1360 or 1370 may be transmitted to the other wireless communication network as the wireless transmit signal. Thereby, the relay device may implement a bridge between the wireless communication networks 1360 and 1370.

One or more of the relay devices 81₁ to 81₄ may be operated as so-called enhanced relay devices. For example, such devices may receive signals that are not only dedicated for relaying on a point-to-point manner.

For example, with reference to FIG. 13E the relay 81₃ and/or 81₄ (R) can be considered as a network separator or bridge. Two core networks 79₁ and 79₂ (CNs) are shown.

A relay 81₁ top 81₄ in may be a separate entity or combined with a mobile termination, MT, and/or a base station, gNB to form a device capable of relaying traffic.

For example, the MT/gNB block 844 in FIG. 13E in the lower part may be a combination of a UE and a base station, providing RAN access to UE 2. UE 1 can also access the lower CN 79₂ via a connection of the MT/gNB node 81₃ and an optional relay 81₂.

The top CN 79₁ and the bottom CN 79₂ of FIG. 13E are different CNs, i.e., not the same, and can be operated as full core networks or as virtual core networks within another core network providing flexibility to MNOs and non-public-network, NPN, providers.

While the CN 79₁ may manage the public network 1360, the core network 79₂ may manage the NPN network 1370. For the NPN part to be able to work properly, the CN 79₂ may be needed to be available for the MT/gNB device 81₃. Therefore two main options exist for the MT/gNB device:
Connection to the CN 79₂ via the MT or Relay 81₃ connected to the CN 79₁; and/or
Hosting CN 79₂ within the NPN 1370, e.g. at the MT/gNB 81₃ device without requiring the CN 79₁ to operate.

Shown is an example scenario with a relay device providing bridging capabilities between MNO1 and non-public network (NPN), e.g. a cruise ship or a factory. In these scenarios the NPN can host its on CN or CN can be forwarded through the MT/gNB.

The first network may form a “backhaul” or “anchor” path to (R) (the relay or bridge). Furthermore, the operation of the relay can comprise
Forwarding in one direction only, e.g. DL can be received at the UE1 but the UL needs to be relayed due to UL pathloss constraints.
Bidirectional Forwarding, i.e. both UL and DL directions.

An enhanced Relay node, may support functionalities like sending/receiving
a relay wake up signal (from UE, BS, other relays, . . . to potential relays (sending such a signal may wake up others, e.g., from a discontinuous reception mode, DRX))
a go to sleep signal/message
a paging signal/message
a configuration signal/message

For example, this may allow to inform the other UE(s) about a timing of messages, repetitions, physical layer properties, routing parameters, DRX configuration, QoS requirements/profiles; change of system information (from previous devices); forwarding of received configuration information.

The second network (NW) can be a different public network or a non-public NW, a private NW or a campus NW that uses Uu, sidelink, or other connections such as Bluetooth, Wi-Fi or Li-Fi connections. The relay device may use such connection for communication.

The configuration of the second network may be done by one or more of the following:
First network's CN 79₁
Second network's CN 79₂
Autonomously by gNB in the second network 1370

The routing from gNB A to UE 1 may be either:
Fully-transparent to one or both ends of the communication link; or
Partially-transparent as far as the relay (R).

### Such Aspects May be Formulated as

A transceiver configured for establishing a Uu connection with a user equipment of the wireless communication network and for transmitting the wireless transmit signal to user equipment or receiving the wireless receive signal from the user equipment.

A transceiver, wherein the Uu connection is a first Uu connection, the transceiver being configured for establishing a second Uu connection with a further device such as a base station, a relay device or a user equipment, wherein the transceiver is configured for receiving the wireless receive signal and transmitting the wireless transmit signal using the first and the second Uu connection.

{PC5 Multihop—Taken from Telephone Conversation}

A transceiver, configured for receiving the wireless receive signal using a first PC5 connection established with a first device and for transmitting the wireless transmit signal using a second PC5 connection established with a second device.

A transceiver, wherein the first device is a relay device or a user equipment; and wherein the second device is a relay device or a user equipment.

A transceiver, wherein in a first operating mode the transceiver is configured for simultaneously relaying signals in uplink and downlink.

A transceiver, wherein in a second operating mode the transceiver is configured for simultaneously relaying signals only in one of uplink and downlink, e.g., as a part of a multi-TRP configuration.

A transceiver, configured for receiving, e.g., from a base station, information indicating a configuration of resources of a sidelink; and from broadcasting, groupcasting or unicasting a resource pool configuration based on the information indicating a configuration of resources of a sidelink.

A transceiver, configured for monitoring a link property such as capacity, load, throughput of a first link used for receiving the wireless receive signal or of a second link used for transmitting the wireless transmit signal and for providing a report indicating the property.

A transceiver, configured for receiving the wireless receive signal from a first wireless communication network and to transmit the wireless transmit signal to a different second wireless communication network;

A transceiver that implements a bridge between the first and second wireless communication network.

A transceiver, configured for receiving at least one of:
a relay wake up message/signal;
a go-to-sleep message/signal;
a paging message/signal; and
a configuration message/signal; and
for operating accordingly.

A transceiver, configured for transmitting at least one of:
a relay wake up message/signal;
a go-to-sleep message/signal;
a paging message/signal; and
a configuration message/signal.

A transceiver, being a user equipment, UE, for operating in a wireless communication network and for at least temporarily operating as a relay device.

A transceiver, configured for using at least one of:
a non-3GPP connection, e.g., using Bluetooth, WiFi or LiFi, and
a 3GPP connection.
   for receiving the wireless receive signal and/or for transmitting the wireless transmit signal.

A transceiver, wherein the transceiver is configured for providing at least a part of an access and mobility management function, AMF, and/or a location management function, LMF, for at least one device, e.g., in case of a missing backhaul link.

A device such as a user equipment may advantageously be configured for recognising the transceiver based on at least one of information indicating a configuration of resources of a sidelink or a resource pool configuration.

Such a device may, as an alternative or in addition be configured for selecting a path segment to be used for signal relaying as a path segment provided by the transceiver and based on a report indicating a property such as capacity, load, throughput, of a link providing the path segment.

Such a device may, as an alternative or in addition be configured for establishing a Uu connection with the transceiver.

Such a device may, as an alternative or in addition be provided with service by a first mobile network operator, MNO, wherein the transceiver is provided with service by a second mobile network operator, MNO.

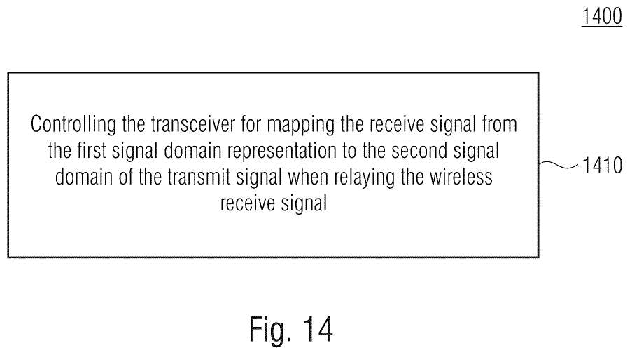

FIG. 14 shows a schematic flow chart 1400 of a method for operating a transceiver, according to an embodiment. A step 1410 comprises a step 1410 of controlling the transceiver for mapping the receive signal from the first signal domain representation to the second signal domain of the transmit signal when relaying the wireless receive signal.

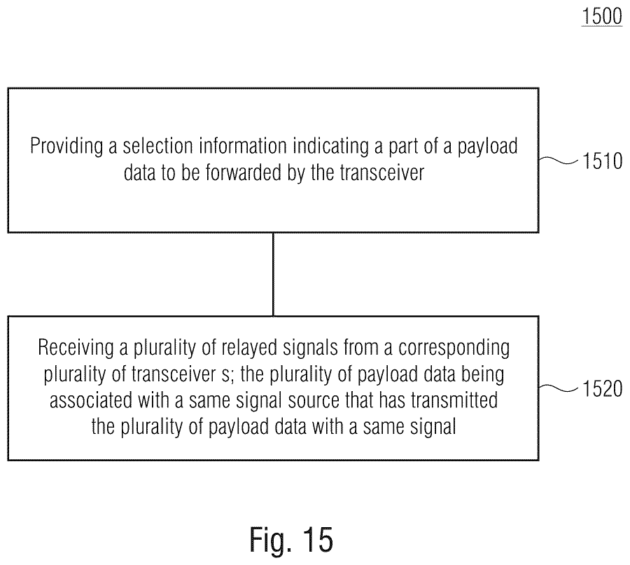

FIG. 15 shows a schematic flow chart of a method 1500 according to an embodiment. A step 1510 comprises providing a selection information indicating a part of a payload data to be forwarded by the transceiver. A step 1520 that may be executed as an alternative to step 1510 or in addition to step 1510 comprises receiving a plurality of relayed signals from a corresponding plurality of transceiver s; the plurality of payload data being associated with a same signal source that has transmitted the plurality of payload data with a same signal.

Further aspects of the present invention, e.g., in view of the first technical aspect relate to a relay device configured for relaying a wireless receive signal as a wireless transmit signal, wherein the relay device is configured for swapping between a Time Division Duplex, TDD, scheme and a Frequency Division Duplex, FDD, scheme when relaying the wireless receive signal.

According to an embodiment, such a relay device is configured for receiving the wireless receive signal as a signal according to the TDD scheme and for transmitting the wireless transmit signal according to the FDD scheme; or wherein the relay is configured for receiving the wireless receive signal as a signal according to the FDD scheme and for transmitting the wireless transmit signal according to the TDD scheme.

According to an embodiment, such a relay device is configured for relaying according to at least one of: an amplify and forward relaying; a digitize and forward relaying; and a store and forward relaying.

According to an embodiment, such a relay device is configured for aggregating a plurality of wireless receive signals into a set of at least one wireless transmit signal, the set comprising the wireless transmit signal.

Further aspects of the present invention, e.g., in view of the first technical aspect relate to a relay device, e.g., a device that may operate jointly with other devices] configured for relaying a plurality of wireless receive signals as at least one wireless transmit signal; wherein the relay device is configured for aggregating the plurality of wireless receive signals into the at least one wireless transmit signal.

According to an embodiment, such a relay device is adapted for a cell-free operation of a wireless communications network cell operated by a base station.

According to an embodiment, such a relay device is configured for swapping between a Time Division Duplex, TDD, scheme and a Frequency Division Duplex, FDD, scheme when relaying the wireless receive signal.

In an embodiment, a computer readable digital storage medium has stored therein a computer program having a program code for performing, when running on a computer, a method described herein.

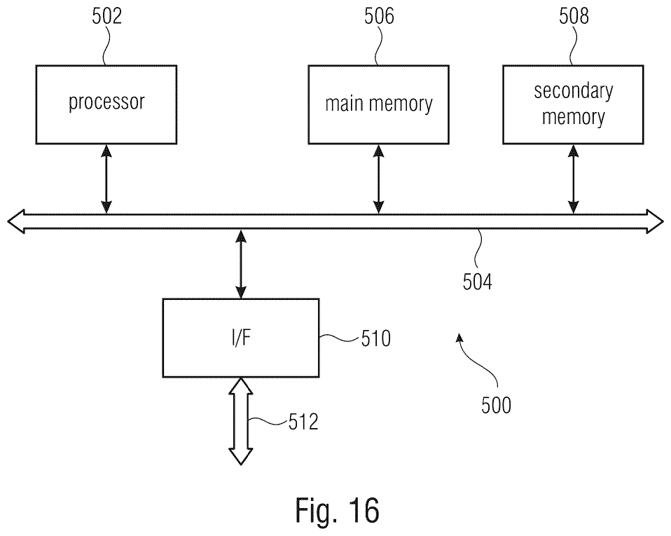

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] L. You, K.-X. Li, J. Wang, X. Gao, X.-G. Xia and B. Otterstenx, “LEO Satellite Communications with Massive MIMO,” ICC 2020-2020 IEEE International Conference on Communications (ICC), Dublin, Ireland, 2020, pp. 1-6, doi: 10.1109/ICC40277.2020.9149121]
[2] Distributed Massive MIMO for LEO Satellite Networks, arXiv: 2211.00832 https://arxiv.org/abs/2211.00832
[3] Capacity Analysis and Optimization of Satellite MIMO System” written by Haijin Li, Jianbo Li, Yuxin Cheng, Jianjun Wu, published by International Journal of Communications, Network and System Sciences, Vol. 10 No. 5B, 2017 https://www.scirp.org/journal/paperinformation.aspx?paperid=76553
[4] Robust Downlink Transmission for 6G LEO-MIMO Satellite Systems https://www.hindawi.com/journals/wcmc/2022/6235241/
[5] A Hybrid Beamforming Design for Massive MIMO LEO Satellite Communications https://doi.org/10.3389/frspt.2021.696464
[6] Z. Katona, “GEO data relay for low earth orbit satellites,” 2012 6th Advanced Satellite Multimedia Systems Conference (ASMS) and 12th Signal Processing for Space Communications Workshop (SPSC), Vigo, Spain, 2012, pp. 81-88, doi: 10.1109/ASMS-SPSC.2012.6333111 https://ieeexplore.ieee.org/document/6333111
[7] Optical High-Capacity Satellite Downlinks via High-Altitude Platform Relays https://elib.dlr.de/53611/1/2007_Paper_HAPs_Relais_for_FSO_Copyright.pdf
[8] Integrating LEO Satellite and UAV Relaying via Reinforcement Learning for Non-Terrestrial Networks, https://arxiv: 2005.12521v1

| Abbre- | | Further |
|---|---|---|
| viation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received | |
| | signal strength | |
| CP | control plane | |
| CP1 | control plane 1 | |
| CP2 | control plane 2 | |
| CPRI | common public radio interface | |
| CSI | channel state information | |
| CSI-IM | CSI interference measurement | |
| CSI-RS | CSI reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIB | message information block | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| | | plane and control |
| | | plane protocol |
| | | terminations |
| | | towards the UE, |
| | | and connected |
| | | via the NG |
| | | interface to |
| | | the 5GC |
| NG-RAN | either a gNB or an NG-eNB | |
| NGSO | non-geostationary orbit | |
| NIC | network interface connection | |
| NR | new radio | |
| NR-U | NR unlicensed | NR operating |
| | | in unlicensed |
| | | frequency |
| | | spectrum |
| NTN | non-terrestrial network | |
| NZP-CSI-RS | non-zero-power CSI-RS | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PDCCH | physical downlink control channel | |
| PDSCH | physical downlink shared channel | |
| PER | packet error rate | |
| PHY | physical | |
| PLMN | public land mobile network | |
| PRACH | physical random access channel | |
| PUCCH | physical uplink control channel | |
| PUSCH | physical uplink shared channel | |
| PSBCH | physical sidelink broadcast channel | |
| PSCCH | physical sidelink control channel | |
| PSSCH | physical sidelink shared channel | |
| PSFCH | physical sidelink feedback channel | |
| QCL | quasi colocation | |
| RA | random access | |
| RACH | random access channel | |
| RAN | radio access network | |
| RAT | radio access technology | |
| RF | radio frequency | |
| RIM | radio access network information | |
| | management | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | srs resource indicator | |
| SS | synchronization signal | |
| SSB | synchronization signal block | |
| SSID | service set identifier | |
| SS-PBCH | sounding signal/physical broadcast | |
| | channel | |
| TAC | tracking area code | |
| TB | transmission block | |
| TCI | transmission configuration indication | |
| TDD | time division duplex | |
| TN | terrestrial network | |
| TRD | transmit/receive device | |
| TRP | transmission reference point/ | |
| | transmission reception point | |
| TSG | technical specification group | |
| UAV | uncrewed airborne vehicle | |
| UE | user equipment | |
| UL | uplink | |
| UP | user plane | |
| URLLC | ultra-reliable low latency | |
| | communication | |
| UTRAN | universal trunked radio access network | |
| Uu | UU interface/access link | |
| V2X | vehicle-to-everything | |
| VoIP | voice over internet protocol | |
| vRAN | virtual ran | |
| WI | work item | |
| WLAN | wireless local area network | |
| ZP-CSI-RS | zero-power CSI-RS | |

1. A transceiver configured for relaying a wireless receive signal in a first signal domain representation as a wireless transmit signal in a second signal domain representation;
wherein the transceiver is configured for mapping the receive signal from the first signal domain representation to the second signal domain representation of the transmit signal when relaying the wireless receive signal.

2. The transceiver of claim 1, wherein the first signal domain representation and the second signal domain representation differ from each other in view of at least two of the following:
a time domain such as delay, repetition, store and forward;
a delay domain such as cyclic delay diversity, delay precoding in OTFS;
a frequency domain such as frequency translation;
a Doppler domain such as Doppler precoding in OTFS;
a power domain such as amplification through repeaters or decode and forward relaying;
an energy domain such as distribution of signal power over time and frequency;
a code domain such as different spreading and scrambling sequences, fountain codes code rates;
an orbital angular momentum domain;
a spatial domain such as patterns, beam formers, sectors, directions;
a coverage domain such as indoors, outdoors; and
a polarisation domain such as linear to linear, linear to circular, circular to linear.

3. The transceiver according to claim 1, configured for providing communication between a first device and a second device;
wherein the transceiver is configured for providing the communication by the relaying in at least a first direction from the first device to the second device or a second direction from the second device to the first device

4. The transceiver of claim 1, wherein the transceiver is configured for performing, by the relaying, a mapping between a first duplex scheme of a first link between a first device and the transceiver and a second duplex scheme of a second link between at least one second device and the transceiver.

5. The transceiver of claim 1, configured for mapping between a Time Division Duplex, TDD, scheme of a time domain and a Frequency Division Duplex, FDD, scheme of a frequency domain when relaying the wireless receive signal.

6. The transceiver of claim 5, wherein the transceiver is configured for receiving the wireless receive signal as a signal according to the TDD scheme and for transmitting the wireless transmit signal according to the FDD scheme; or wherein the transceiver is configured for receiving the wireless receive signal as a signal according to the FDD scheme and for transmitting the wireless transmit signal according to the TDD scheme; or
wherein the transceiver is configured for adapting a ratio between a first amount of wireless transmit signals transmitted based on a second amount of wireless receive signals.

7. The transceiver of claim 1, configured for wirelessly receiving a configuration signal indicating configuration parameters for the transceiver relating to at least the mapping; wherein the transceiver is configured for operating accordingly.

8. The transceiver of claim 7, wherein the configuration signal comprises information indicating at least one of:
available resources on UE-relay link and relay-satellite link;
UE-relay association;
a relay-satellite association;
a relay-UAV association;
a relay-satellite network association;
a relay-UAV network association;
an operational/coverage/connectivity area;
an opportunity/availability for communication of the link;
an operational parameter such as one or more of a list of frequency bands, allowed transmission powers, MIMO Modes;
a synchronization source such as GPS, local sync source, further relay with master clock; and
a relay software version or availability such as an update over the air.

9. The transceiver according to claim 1, wherein the transceiver is adapted to relaying only a selected part of the receive signal payload data.

10. The transceiver of claim 9, wherein the receive signal comprises payload data and wherein the selected part is a part of the payload;
the complete payload;
an incremental replica of at least a part of the payload;
multiple redundant copies including full and partial redundancy;
Combinations of the above; and/or,
wherein the selected part is associated with
a control plane
a user plane
a management plane.

11. The transceiver of claim 9, wherein the transceiver is configured for receiving a selection information, e.g., from a base station or from a device transmitting the receive signal, and for selecting the selected part based on the selection information.

12. The transceiver according to claim 1, comprising a relaying capability to relay signals;
wherein the transceiver is configured to transmit a capability information related to the relaying capability,
wherein optionally the transceiver is configured to include, into the capability information, at least one of:
a number of antennas and/or a type of at least one antenna;
a supported transmit power;
a supported number of frequency bands and associated bandwidths and/or a subcarrier spacing;
a supported number of MIMO layers on at least one communication side, e.g., a UE side;
an electrical parameter of the transceiver such as a battery status;
a synchronization information indicating a synchronization state of the transceiver;
an available resources for receiving the receive signal and/or for transmitting the transmit signal, e.g., terrestrial and/or satellite;
a mobility property, speed and/or position;
a temporal availability of the transceiver;
a signal quality of at least one link on which the transceiver transmits or receives a signal;
an owner/provider/operator of the transceiver;
a relaying group, e.g., a part of which the transceiver is;
a supported processing time; and
a battery state or power indicator such as a remaining battery lifetime, battery charging information.

13. The transceiver according to claim 1, configured for establishing a Uu connection with a network device of the wireless communication network and for transmitting the wireless transmit signal to user equipment or receiving the wireless receive signal from the user equipment.

14. The transceiver according to claim 1, configured for receiving the wireless receive signal using a first PC5 connection established with a first device and for transmitting the wireless transmit signal using a second PC5 connection established with a second device.

15. The transceiver according to claim 1, configured for receiving the wireless receive signal using a PC5 connection established with a first device and for transmitting the wireless transmit signal using a Uu connection established with a second device; and/or for receiving the wireless receive signal using a Uu connection established with a first device and for transmitting the wireless transmit signal using a PC5 connection established with a second device.

16. The transceiver according to claim 14, wherein the first device is a relay device, a base station or a user equipment; and wherein the second device is a relay device, a base station or a user equipment.

17. The transceiver according to claim 1, configured for receiving at least one of:
a relay wake up message/signal;
a go-to-sleep message/signal;
a paging message/signal; and
a configuration message/signal; and
for operating accordingly.

18. The transceiver according to claim 1, configured for transmitting at least one of:
a relay wake up message/signal;
a go-to-sleep message/signal;
a paging message/signal; and
a configuration message/signal.

19. The transceiver according to claim 1, being a user equipment, UE, for operating in a wireless communication network and for at least temporarily operating as a relay device.

20. The transceiver according to claim 1, wherein the transceiver is configured for providing at least a part of an access and mobility management function, AMF, and/or a location management function, LMF, for at least one device, e.g., in case of a missing backhaul link.

21. A device configured for utilizing a wireless communication link that comprises a transceiver for relaying a wireless signal towards or from the device,
wherein the device is configured for providing a selection information indicating a part of a payload data to be forwarded by the transceiver; and/or
wherein the device is configured for receiving a plurality of relayed signals from a corresponding plurality of transceivers; the plurality of payload data being associated with a same signal source that has transmitted the plurality of payload data with a same signal.
